(19) United States
(12) Patent Application Publication
(10) Pub. No.: US 2025/0220168 A1
(43) Pub. Date: Jul. 3, 2025

(54) A METHOD, AN APPARATUS AND A COMPUTER PROGRAM PRODUCT FOR VIDEO ENCODING AND VIDEO DECODING

(71) Applicant: Nokia Technologies Oy, Espoo (FI)

(72) Inventors: Ramin GHAZNAVI YOUVALARI, Tampere (FI); Miska Matias HANNUKSELA, Tampere (FI); Jukka Ilari AHONEN, Tampere (FI); Francesco CRICRÌ, Tampere (FI); Honglei ZHANG, Tampere (FI); Nam Hai LE, Tampere (FI)

(21) Appl. No.: 18/852,487

(22) PCT Filed: Feb. 13, 2023
(86) PCT No.: PCT/FI2023/050085

§ 371 Date: Sep. 29, 2024

(30) Foreign Application Priority Data
Apr. 7, 2022 (FI) 20225304

(51) Int. Cl. H04N 19/117; H04N 19/147; H04N 19/172; H04N 19/196

(52) U.S. Cl. CPC H04N 19/117; H04N 19/147; H04N 19/172; H04N 19/196

(57) ABSTRACT

The embodiments relate to a method for encoding/decoding. The encoding method (900) comprises receiving a video sequence (1505) comprising a first frame and a second frame; encoding (1510) the first frame into a first coded frame using a first coding method (901); reconstructing (1515) a first decoded frame corresponding to the first coded frame; deriving (1520) one or more optimizing parameters to adjust a traditional filter (1110), wherein the optimizing parameters reduce distortion of the first decoded frame to produce a first filtered frame; filtering (1525) the first decoded frame with the traditional filter (1010, 1110); encoding (1530) the second frame into a second coded frame by a second set of algorithms of the second coding method (906, 1210) and by using the first filtered frame directly or indirectly for prediction; and signalling (1535) said one or more optimizing parameters. The embodiments also relate to apparatuses for encoding/decoding.

The project leading to this application has received funding from the ECSEL Joint Undertaking (JU) under grant agreement No 876019. The JU receives support from the European Union's Horizon 2020 research and innovation programme and Germany, Netherlands, Austria, Romania, France, Sweden, Cyprus, Greece, Lithuania, Portugal, Italy, Finland, Turkey.

### TECHNICAL FIELD

The present solution generally relates to video encoding and video decoding.

### BACKGROUND

One of the elements in image and video compression is to compress data while maintaining the quality to satisfy human perceptual ability. However, in recent development of machine learning, machines can replace humans when analyzing data for example in order to detect events and/or objects in video/image. Thus, when decoded image data is consumed by machines, the quality of the compression can be different from the human approved quality. Therefore, a concept Video Coding for Machines (VCM) has been provided.

### SUMMARY

The scope of protection sought for various embodiments of the invention is set out by the independent claims. The embodiments and features, if any, described in this specification that do not fall under the scope of the independent claims are to be interpreted as examples useful for understanding various embodiments of the invention.

Various aspects include a method, an apparatus and a computer readable medium comprising a computer program stored therein, which are characterized by what is stated in the independent claims. Various embodiments are disclosed in the dependent claims.

According to a first aspect, there is provided an apparatus comprising means for receiving a video sequence comprising a first frame and a second frame; means for encoding the first frame into a first coded frame using a first coding method; means for reconstructing a first decoded frame corresponding to the first coded frame; means for deriving one or more optimizing parameters to adjust a traditional filter, wherein the optimizing parameters reduce distortion of the first decoded frame to produce a first filtered frame; means for filtering the first decoded frame with the traditional filter; means for encoding the second frame into a second coded frame by a second set of algorithms of the second coding method and by using the first filtered frame directly or indirectly for prediction; and means for signalling said one or more optimizing parameters.

According to a second aspect, there is provided an apparatus for decoding comprising means for receiving a first coded frame and a second coded frame; means for receiving one or more optimizing parameters; means for decoding the first coded frame into a first decoded frame using a first decoding method; means for adjusting a traditional filter with the one or more optimizing parameters, where the optimizing parameters reduce distortion of the first decoded frame to produce a first filtered frame; means for filtering the first decoded frame with the traditional filter; means for decoding the second coded frame into a second decoded frame by a second set of algorithms of the second decoding method and by using the first filtered frame directly or indirectly for prediction.

According to a third aspect, there is provided a method for encoding, comprising receiving a video sequence comprising a first frame and a second frame; encoding the first frame into a first coded frame using a first coding method; reconstructing a first decoded frame corresponding to the first coded frame; deriving one or more optimizing parameters to adjust a traditional filter, wherein the optimizing parameters reduce distortion of the first decoded frame to produce a first filtered frame; filtering the first decoded frame with the traditional filter; encoding the second frame into a second coded frame by a second set of algorithms of the second coding method and by using the first filtered frame directly or indirectly for prediction; and signalling said one or more optimizing parameters.

According to a fourth aspect, there is provided a method for decoding, comprising receiving a first coded frame and a second coded frame; receiving one or more optimizing parameters; decoding the first coded frame into a first decoded frame using a first decoding method; adjusting a traditional filter with the one or more optimizing parameters, where the optimizing parameters reduce distortion of the first decoded frame to produce a first filtered frame; filtering the first decoded frame with the traditional filter; decoding the second coded frame into a second decoded frame by a second set of algorithms of the second decoding method and by using the first filtered frame directly or indirectly for prediction.

According to a fifth aspect, there is provided an apparatus for encoding comprising at least one processor, memory including computer program code, the memory and the computer program code configured to, with the at least one processor, cause the apparatus to perform at least the following: receive a video sequence comprising a first frame and a second frame; encoding the first frame into a first coded frame using a first coding method; reconstruct a first decoded frame corresponding to the first coded frame; derive one or more optimizing parameters to adjust a traditional filter, wherein the optimizing parameters reduce distortion of the first decoded frame to produce a first filtered frame; filter the first decoded frame with the traditional filter; encode the second frame into a second coded frame by a second set of algorithms of the second coding method and by using the first filtered frame directly or indirectly for prediction; and signal said one or more optimizing parameters.

According to a sixth aspect, there is provided an apparatus for decoding comprising at least one processor, memory including computer program code, the memory and the computer program code configured to, with the at least one processor, cause the apparatus to perform at least the following: receive a first coded frame and a second coded frame; receive one or more optimizing parameters; decode the first coded frame into a first decoded frame using a first decoding method; adjust a traditional filter with the one or more optimizing parameters, where the optimizing parameters reduce distortion of the first decoded frame to produce a first filtered frame; filter the first decoded frame with the traditional filter; decode the second coded frame into a second decoded frame by a second set of algorithms of the second decoding method and by using the first filtered frame directly or indirectly for prediction.

According to a seventh aspect, there is provided computer program product comprising computer program code configured to, when executed on at least one processor, cause an apparatus or a system to receive a video sequence comprising a first frame and a second frame; encoding the first frame into a first coded frame using a first coding method; reconstruct a first decoded frame corresponding to the first coded frame; derive one or more optimizing parameters to adjust a traditional filter, wherein the optimizing parameters reduce distortion of the first decoded frame to produce a first filtered frame; filter the first decoded frame with the traditional filter; encode the second frame into a second coded frame by a second set of algorithms of the second coding method and by using the first filtered frame directly or indirectly for prediction; and signal said one or more optimizing parameters.

According to an eighth aspect, there is provided computer program product comprising computer program code configured to, when executed on at least one processor, cause an apparatus or a system to receive a first coded frame and a second coded frame; receive one or more optimizing parameters; decode the first coded frame into a first decoded frame using a first decoding method; adjust a traditional filter with the one or more optimizing parameters, where the optimizing parameters reduce distortion of the first decoded frame to produce a first filtered frame; filter the first decoded frame with the traditional filter; decode the second coded frame into a second decoded frame by a second set of algorithms of the second decoding method and by using the first filtered frame directly or indirectly for prediction.

According to an embodiment,

According to an embodiment, the encoding comprises encoding the first decoded frame by a first set of algorithms of a second coding method, wherein the encoding comprises or is followed by reconstructing another first decoded frame, and filtering the another first decoded frame with the traditional filter using said one or more optimizing parameters into another first decoded and filtered frame, wherein the another first decoded and filtered frame is used directly for prediction of the second frame.

According to an embodiment, the deriving said one or more optimizing parameters comprises deriving the distortion in relation to the first frame.

According to an embodiment, the first coding method is an end-to-end learned image coding method.

According to an embodiment, the first set of algorithms of the second coding method reconstructs the another first decoded frame to be identical or substantially identical to the first decoded frame.

According to an embodiment, the distortion is one or more of the following: pixel-wise distortion; feature-element-wise distortion; cross-entropy loss.

According to an embodiment, the encoding further comprises deriving said one or more optimizing parameters by a rate-distortion optimization process.

According to an embodiment, the traditional filter is used in one of the following: picture, slice, tile, sub-picture, coding tree unit, coding unit, prediction unit, transform unit.

According to an embodiment, the encoding comprises encoding said one or more optimizing parameters by the second coding method.

According to an embodiment, the traditional filter is an adaptive loop filter and said means for signaling comprise including said one or more optimizing parameters into an adaptation parameter set defined by the second coding method.

According to an embodiment, the computer program product is embodied on a non-transitory computer readable medium.

### DESCRIPTION OF THE DRAWINGS

In the following, various embodiments will be described in more detail with reference to the appended drawings, in which

FIG. 1 shows an example of a codec with neural network (NN) components;

FIG. 2 shows another example of a video coding system with neural network components;

FIG. 3 shows an example neural network-based end-to-end learned video coding system, in accordance with an example embodiment;

FIG. 4 shows an example of a neural network-based end-to-end learned video coding system;

FIG. 5 shows an example of a video coding for machines;

FIG. 6 shows an example of a pipeline for end-to-end learned system for video coding for machines;

FIG. 7 shows an example of training an end-to-end learned system for video coding for machines;

FIG. 8 shows an example of a video coding for machines system comprising an encoder, a decoder, a post-processing filter and a set of task-NNs;

FIG. 9 shows an example of a general framework according to an embodiment;

FIG. 10 shows an example of pre-filtering the intra-frames for CVC;

FIG. 11 shows an example of optimizing parameters of conventional filters;

FIG. 12 shows an example where conventional filters are part of a CVC codec;

FIG. 13 shows an example of optimizing conventional filters to be used for post-processing after CVC decoding;

FIG. 14 shows an example of several sets of parameters targeted to different post-processing purpose;

FIG. 15 is a flowchart illustrating a method according to an embodiment;

FIG. 16 is a flowchart illustrating a method according to another embodiment; and

FIG. 17 shows an example of an apparatus.

### DESCRIPTION OF EXAMPLE EMBODIMENTS

The following description and drawings are illustrative and are not to be construed as unnecessarily limiting. The specific details are provided for a thorough understanding of the disclosure. However, in certain instances, well-known or conventional details are not described in order to avoid obscuring the description. References to one or an embodiment in the present disclosure can be, but not necessarily are, reference to the same embodiment and such references mean at least one of the embodiments.

Reference in this specification to “one embodiment” or “an embodiment” means that a particular feature, structure, or characteristic described in connection with the embodiment is included in at least one embodiment of the disclosure.

In the present disclosure, terms “data,” “content,” “information,” and similar terms may be used interchangeably to refer to data capable of being transmitted, received and/or stored in accordance with embodiments of the present invention.

In the present disclosure a term “computer-readable storage medium” refers to a physical storage medium (e.g., volatile or non-volatile memory device), may be differentiated from a “computer-readable transmission medium,” which refers to an electromagnetic signal.

The present embodiments provide optimized conventional filters for hybrid neural network based video coding and conventional video coding.

Before discussing the present embodiments in more detailed manner, a short reference to related technology is given.

A neural network (NN) is a computation graph consisting of several layers of computation. Each layer consists of one or more units, where each unit performs an elementary computation. A unit is connected to one or more other units, and the connection may have associated with a weight. The weight may be used for scaling the signal passing through the associated connection.

Weights are learnable parameters, i.e., values which can be learned from training data. There may be other learnable parameters, such as those of batch-normalization layers.

Two of the most widely used architectures for neural networks are feed-forward and recurrent architectures. Feed-forward neural networks are such that there is no feedback loop: each layer takes input from one or more of the layers before and provides its output as the input for one or more of the subsequent layers. Also, units inside a certain layer take input from units in one or more of preceding layers and provide output to one or more of following layers.

Initial layers (those close to the input data) extract semantically low-level features such as edges and textures in images, and intermediate and final layers extract more high-level features. After the feature extraction layers there may be one or more layers performing a certain task, such as classification, semantic segmentation, object detection, denoising, style transfer, super-resolution, etc. In recurrent neural nets, there is a feedback loop, so that the network becomes stateful, i.e., it is able to memorize information or a state.

Neural networks are being utilized in an ever-increasing number of applications for many different types of device, such as mobile phones.

Examples include image and video analysis and processing, social media data analysis, device usage data analysis, etc.

One of the important properties of neural networks (and other machine learning tools) is that they are able to learn properties from input data, either in supervised way or in unsupervised way. Such learning is a result of a training algorithm, or of a meta-level neural network providing the training signal.

In general, the training algorithm consists of changing some properties of the neural network so that its output is as close as possible to a desired output. For example, in the case of classification of objects in images, the output of the neural network can be used to derive a class or category index which indicates the class or category that the object in the input image belongs to. Training usually happens by minimizing or decreasing the output's error, also referred to as the loss. Examples of losses are mean squared error, cross-entropy, etc. In recent deep learning techniques, training is an iterative process, where at each iteration the algorithm modifies the weights of the neural net to make a gradual improvement of the network's output, i.e., to gradually decrease the loss.

In this description, terms “model” and “neural network” are used interchangeably, and also the weights of neural networks are sometimes referred to as learnable parameters or simply as parameters.

Training a neural network is an optimization process. The goal of the optimization or training process is to make the model learn the properties of the data distribution from a limited training dataset. In other words, the goal is to learn to use a limited training dataset in order to learn to generalize to previously unseen data, i.e., data which was not used for training the model. This is usually referred to as generalization. In practice, data may be split into at least two sets, the training set and the validation set. The training set is used for training the network, i.e., to modify its learnable parameters in order to minimize the loss. The validation set is used for checking the performance of the network on data, which was not used to minimize the loss, as an indication of the final performance of the model. In particular, the errors on the training set and on the validation set are monitored during the training process to understand the following things:
If the network is learning at all—in this case, the training set error should decrease, otherwise the model is in the regime of underfitting.
If the network is learning to generalize—in this case, also the validation set error needs to decrease and to be not too much higher than the training set error. If the training set error is low, but the validation set error is much higher than the training set error, or it does not decrease, or it even increases, the model is in the regime of overfitting. This means that the model has just memorized the training set's properties and performs well only on that set but performs poorly on a set not used for tuning its parameters.

Lately, neural networks have been used for compressing and de-compressing data such as images, i.e., in an image codec. The most widely used architecture for realizing one component of an image codec is the auto-encoder, which is a neural network consisting of two parts: a neural encoder and a neural decoder. The neural encoder takes as input an image and produces a code which requires less bits than the input image. This code may be obtained by applying a binarization or quantization process to the output of the encoder. The neural decoder takes in this code and reconstructs the image which was input to the neural encoder.

Such neural encoder and neural decoder may be trained to minimize a combination of bitrate and distortion, where the distortion may be based on one or more of the following metrics: Mean Squared Error (MSE), Peak Signal-to-Noise Ratio (PSNR), Structural Similarity Index Measure (SSIM), or similar. These distortion metrics are meant to be correlated to the human visual perception quality, so that minimizing or maximizing one or more of these distortion metrics results into improving the visual quality of the decoded image as perceived by humans.

Video codec comprises an encoder that transforms the input video into a compressed representation suited for storage/transmission and a decoder that can decompress the compressed video representation back into a viewable form. An encoder may discard some information in the original video sequence in order to represent the video in a more compact form (that is, at lower bitrate).

The H.264/AVC standard was developed by the Joint Video Team (JVT) of the Video Coding Experts Group (VCEG) of the Telecommunications Standardization Sector of International Telecommunication Union (ITU-T) and the Moving Picture Experts Group (MPEG) of International Organization for Standardization (ISO)/International Electrotechnical Commission (IEC). The H.264/AVC standard is published by both parent standardization organizations, and it is referred to as ITU-T Recommendation H.264 and ISO/IEC International Standard 14496-10, also known as MPEG-4 Part 10 Advanced Video Coding (AVC). Extensions of the H.264/AVC include Scalable Video Coding (SVC) and Multiview Video Coding (MVC).

The High Efficiency Video Coding (H.265/HEVC a.k.a. HEVC) standard was developed by the Joint Collaborative Team-Video Coding (JCT-VC) of VCEG and MPEG. The standard was published by both parent standardization organizations, and it is referred to as ITU-T Recommendation H.265 and ISO/IEC International Standard 23008-2, also known as MPEG-H Part 2 High Efficiency Video Coding (HEVC). Later versions of H.265/HEVC included scalable, multiview, fidelity range, three-dimensional, and screen content coding extensions which may be abbreviated SHVC, MV-HEVC, REXT, 3D-HEVC, and SCC, respectively.

Versatile Video Coding (H.266 a.k.a. VVC), defined in ITU-T Recommendation H.266 and equivalently in ISO/IEC 23090-3, (also referred to as MPEG-I Part 3) is a video compression standard developed as the successor to HEVC.

A specification of the AV1 bitstream format and decoding process were developed by the Alliance of Open Media (AOM). The AV1 specification was published in 2018. AOM is reportedly working on the AV2 specification.

An elementary unit for the input to a video encoder and the output of a video decoder, respectively, in most cases is a picture. A picture given as an input to an encoder may also be referred to as a source picture, and a picture decoded by a decoder may be referred to as a decoded picture or a reconstructed picture.

The source and decoded pictures are each comprises of one or more sample arrays, such as one of the following sets of sample arrays:
Luma (Y) only (monochrome),
Luma and two chroma (YCbCr or YCgCo),
Green, Blue, and Red (GBR, also known as RGB),
Arrays representing other unspecified monochrome or tri-stimulus color samplings (for example, YZX, also known as XYZ).

A component may be defined as an array or single sample from one of the three sample arrays (luma and two chroma) that compose a picture, or the array or a single sample of the array that compose a picture in monochrome format.

Coding standards or specifications may specify “profiles” and “levels.” A profile may be defined as a subset of algorithmic features of the standard (of the encoding algorithm or the equivalent decoding algorithm). In another definition, a profile is a specified subset of the syntax of the standard (and hence implies that the encoder may only use features that result into a bitstream conforming to that specified subset and the decoder may only support features that are enabled by that specified subset).

A level may be defined as a set of limits to the coding parameters that impose a set of constraints in decoder resource consumption. In another definition, a level is a defined set of constraints on the values that may be taken by the syntax elements and variables of the standard. These constraints may be simple limits on values. Alternatively, or in addition, they may take the form of constraints on arithmetic combinations of values (e.g., picture width multiplied by picture height multiplied by number of pictures decoded per second). Other means for specifying constraints for levels may also be used. Some of the constraints specified in a level may for example relate to the maximum picture size, maximum bitrate, and maximum data rate in terms of coding units, such as macroblocks, per a time period, such as a second. The same set of levels may be defined for all profiles. It may be preferable for example to increase interoperability of terminals implementing different profiles that most or all aspects of the definition of each level may be common across different profiles.

An indicated profile and level can be used to signal properties of a media stream and/or to signal the capability of a media decoder. Through the combination of a profile and a level, a decoder can determine, without actually attempting the decoding process, whether it is capable of decoding a stream. When the decoder is not capable of decoding a bitstream, an attempt to decode the bitstream may cause the decoder to crash, operate slower than real-time, and/or discard data due to buffer overflows.

Hybrid video codecs (which may also be referred to as conventional video compression codecs or CVC codecs), for example ITU-T H.263 and H.264, may encode the video information in two phases. Firstly, pixel values in a certain picture area (or “block”) are predicted for example by motion compensation means (finding and indicating an area in one of the previously coded video frames that corresponds closely to the block being coded) or by spatial means (using the pixel values around the block to be coded in a specified manner). Secondly the prediction error, i.e., the difference between the predicted block of pixels and the original block of pixels, is coded. This may be done by transforming the difference in pixel values using a specified transform (e.g., Discrete Cosine Transform (DCT) or a variant of it), quantizing the coefficients and entropy coding the quantized coefficients. By varying the fidelity of the quantization process, encoder can control the balance between the accuracy of the pixel representation (picture quality) and size of the resulting coded video representation (file size or transmission bitrate).

Some video coding specifications support lossless coding where the input picture sequence of the encoder is encoded into a bitstream in a manner that the decoder reconstructs an output picture sequence that is identical to the input picture sequence. In lossless coding transform and/or quantization may be omitted and respectively inverse transform and/or dequantization may also be omitted. Respectively, inverse transform and/or dequantization may be omitted in decoding of a losslessly coded bitstream. Some video coding specifications support lossless coding in a region-wise manner.

Inter prediction, which may also be referred to as temporal prediction, motion compensation, or motion-compensated prediction, exploits temporal redundancy. In inter prediction the sources of prediction are previously decoded pictures. When a previously decoded picture (a.k.a. direct reference picture) is used as a reference picture for inter prediction, the previously decoded picture can be regarded as being used directly for prediction. When there is a second previously decoded picture that is used directly for prediction of a first previously decoded picture, and the first previously decoded picture is used directly for prediction of a current picture, it can be considered that the second previously decoded picture is used indirectly for prediction of the current picture. In general, any previously decoded pictures in a chain of inter prediction dependencies for direct reference picture(s) of a current picture can be regarded as indirectly used for prediction of the current picture.

Intra prediction utilizes the fact that adjacent pixels within the same picture are likely to be correlated. Intra prediction can be performed in spatial or transform domain, i.e., either sample values or transform coefficients can be predicted. Intra prediction is typically exploited in intra coding, where no inter prediction is applied.

One outcome of the coding procedure is a set of coding parameters, such as motion vectors and quantized transform coefficients. Many parameters can be entropy-coded more efficiently if they are predicted first from spatially or temporally neighboring parameters. For example, a motion vector may be predicted from spatially adjacent motion vectors and only the difference relative to the motion vector predictor may be coded. Prediction of coding parameters and intra prediction may be collectively referred to as in-picture prediction.

The decoder reconstructs the output video by applying prediction means similar to the encoder to form a predicted representation of the pixel blocks (using the motion or spatial information created by the encoder and stored in the compressed representation) and prediction error decoding (inverse operation of the prediction error coding recovering the quantized prediction error signal in spatial pixel domain). After applying prediction and prediction error decoding means, the decoder sums up the prediction and prediction error signals (pixel values) to form the output video frame. The decoder (and encoder) can also apply additional filtering means to improve the quality of the output video before passing it for display and/or storing it as prediction reference for the forthcoming frames in the video sequence.

In video codecs, the motion information may be indicated with motion vectors associated with each motion compensated image block. Each of these motion vectors represents the displacement of the image block in the picture to be coded (in the encoder side) or decoded (in the decoder side) and the prediction source block in one of the previously coded or decoded pictures. In order to represent motion vectors efficiently, those may be coded differentially with respect to block specific predicted motion vectors. In video codecs, the predicted motion vectors may be created in a predefined way, for example calculating the median of the encoded or decoded motion vectors of the adjacent blocks. Another way to create motion vector predictions is to generate a list of candidate predictions from adjacent blocks and/or co-located blocks in temporal reference pictures and signaling the chosen candidate as the motion vector predictor. In addition to predicting the motion vector values, the reference index of previously coded/decoded picture can be predicted. The reference index is typically predicted from adjacent blocks and/or or co-located blocks in temporal reference picture. Moreover, high efficiency video codecs can employ an additional motion information coding/decoding mechanism, often called merging/merge mode, where all the motion field information, which includes motion vector and corresponding reference picture index for each available reference picture list, is predicted and used without any modification/correction. Similarly, predicting the motion field information may be carried out using the motion field information of adjacent blocks and/or co-located blocks in temporal reference pictures and the used motion field information is signaled among a list of motion field candidate list filled with motion field information of available adjacent/co-located blocks.

In video codecs the prediction residual after motion compensation may be first transformed with a transform kernel (like DCT) and then coded. The reason for this is that often there still exists some correlation among the residual and transform can in many cases help reduce this correlation and provide more efficient coding.

Video encoders may utilize Lagrangian cost functions to find optimal coding modes, e.g., the desired Macroblock mode and associated motion vectors. This kind of cost function uses a weighting factor λ to tie together the (exact or estimated) image distortion due to lossy coding methods and the (exact or estimated) amount of information that is required to represent the pixel values in an image area:

$$C = D + λ R$$

where C is the Lagrangian cost to be minimized, D is the image distortion (e.g., Mean Squared Error) with the mode and motion vectors considered, and R the number of bits needed to represent the required data to reconstruct the image block in the decoder (including the amount of data to represent the candidate motion vectors).

A bitstream may be defined as a sequence of bits or a sequence of syntax structures. A bitstream format may constrain the order of syntax structures in the bitstream.

A syntax element may be defined as an element of data represented in the bitstream. A syntax structure may be defined as zero or more syntax elements present together in the bitstream in a specified order.

In some coding formats or standards, a bitstream may be in the form of a network abstraction layer (NAL) unit stream or a byte stream, that forms the representation of coded pictures and associated data forming one or more coded video sequences.

A NAL unit may be defined as a syntax structure containing an indication of the type of data to follow and bytes containing that data in the form of an RBSP interspersed as necessary with start code emulation prevention bytes. A raw byte sequence payload (RBSP) may be defined as a syntax structure containing an integer number of bytes that is encapsulated in a NAL unit. An RBSP is either empty or has the form of a string of data bits containing syntax elements followed by an RBSP stop bit and followed by zero or more subsequent bits equal to 0.

A NAL unit comprises a header and a payload. The NAL unit header indicates the type of the NAL unit among other things.

In some coding formats, such as AV1, a bitstream may comprise a sequence of open bitstream units (OBUs). An OBU comprises a header and a payload, wherein the header identifies a type of the OBU. Furthermore, the header may comprise a size of the payload in bytes.

NAL units can be categorized into Video Coding Layer (VCL) NAL units and non-VCL NAL units. VCL NAL units are typically coded slice NAL units.

A non-VCL NAL unit may be for example one of the following types: a sequence parameter set, a picture parameter set, a supplemental enhancement information (SEI) NAL unit, an access unit delimiter, an end of sequence NAL unit, an end of bitstream NAL unit, or a filler data NAL unit. Parameter sets may be needed for the reconstruction of decoded pictures, whereas many of the other non-VCL NAL units are not necessary for the reconstruction of decoded sample values.

Some coding formats specify parameter sets that may carry parameter values needed for the decoding or reconstruction of decoded pictures. A parameter may be defined as a syntax element of a parameter set. A parameter set may be defined as a syntax structure that contains parameters and that can be referred to from or activated by another syntax structure for example using an identifier.

A coding standard or specification may specify several types of parameter sets. Some types of parameter sets are briefly described in the following, but it needs to be understood that other types of parameter sets may exist and that embodiments may be applied but are not limited to the described types of parameter sets. A video parameter set (VPS) may include parameters that are common across multiple layers in a coded video sequence or describe relations between layers. Parameters that remain unchanged through a coded video sequence (in a single-layer bitstream) or in a coded layer video sequence may be included in a sequence parameter set (SPS). In addition to the parameters that may be needed by the decoding process, the sequence parameter set may optionally contain video usability information (VUI), which includes parameters that may be important for buffering, picture output timing, rendering, and resource reservation. A picture parameter set (PPS) contains such parameters that are likely to be unchanged in several coded pictures. A picture parameter set may include parameters that can be referred to by the coded image segments of one or more coded pictures. A header parameter set (HPS) has been proposed to contain such parameters that may change on picture basis. In VVC, an Adaptation Parameter Set (APS) may comprise parameters for decoding processes of different types, such as adaptive loop filtering or luma mapping with chroma scaling.

Instead of or in addition to parameter sets at different hierarchy levels (e.g., sequence and picture), video coding formats may include header syntax structures, such as a sequence header or a picture header.

A sequence header may precede any other data of the coded video sequence in the bitstream order. It may be allowed to repeat a sequence header in the bitstream, e.g., to provide a sequence header at a random access point.

A picture header may precede any coded video data for the picture in the bitstream order. A picture header may be interchangeably referred to as a frame header. Some video coding specifications may enable carriage of a picture header in a dedicated picture header NAL unit or a frame header OBU or alike. Some video coding specifications may enable carriage of a picture header in a NAL unit, OBU, or alike syntax structure that also contains coded picture data.

When present, a decoding capability information (DCI) NAL unit carries profile(s) and level(s) that the entire bitstream conforms to.

A random access point may be defined as a location within a bitstream where decoding can be started.

A Random Access Point (RAP) picture may be defined as a picture that serves as a random access point, i.e., as a picture where decoding can be started. In some contexts, the term random-access picture may be used interchangeably with the term RAP picture.

An intra random access point (IRAP) picture, when contained in a single-layer bitstream or an independent layer, may comprise only intra-coded image segments. Furthermore, an IRAP picture may constrain subsequent pictures (within the same layer) in output order to be such that they can be correctly decoded without performing the decoding process of any pictures that precede the IRAP picture in decoding order. There may be pictures in a bitstream that contain only intra-coded slices that are not IRAP pictures.

Some specifications may define a key frame as an intra frame that rests the decoding process when it is shown. Hence, a key frame is similar to an IRAP picture contained in a single-layer bitstream or an independent layer.

In some contexts, an IRAP picture may be defined as one category of random-access pictures, characterized in that they contain only intra-coded image segments, whereas there may also be other category or categories of random-access pictures, such as a gradual decoding refresh (GDR) picture.

Some coding standards or specifications, such as H.264/AVC and H.265/HEVC, may use the NAL unit type of VCL NAL unit(s) of a picture to indicate a picture type. In H.266/VVC, the NAL unit type indicates a picture type when mixed VCL NAL unit types within a coded picture are disabled (pps_mixed_nalu_types_in_pic_flag is equal to 0 in the referenced PPS), while otherwise it indicates a subpicture type.

Types and abbreviations for VCL NAL unit types may include one or more of the following: trailing (TRAIL), Temporal Sub-layer Access (TSA), Step-wise Temporal Sub-layer Access (STSA), Random Access Decodable Leading (RADL), Random Access Skipped Leading (RASL), Instantaneous Decoding Refresh (IDR), Clean Random Access (CRA), Gradual Decoding Refresh (GDR). When all VCL NAL units of a picture have the same NAL unit type, the types and abbreviations may be used as picture types, trailing picture (a.k.a. TRAIL picture).

Some VCL NAL unit types may be more fine-grained as indicated in the paragraph above. For example, two types of IDR pictures may be specified, IDR without leading pictures, IDR with random access decodable leading pictures (i.e., without RASL pictures).

In VVC, an IRAP picture may be a CRA picture or an IDR picture.

Coding standards or specifications may comprise reserved VCL NAL unit type(s) that are reserved for future use to indicate an IRAP picture. For example, in VVC version 1, the NAL unit type (nal_unit_type) value equal to 11 indicates a reserved IRAP VCL NAL unit type.

In HEVC and VVC, provided the necessary parameter sets are available when they are activated or referenced, an IRAP picture at an independent layer and all subsequent non-RASL pictures at the independent layer in decoding order can be correctly decoded without performing the decoding process of any pictures that precede the IRAP picture in decoding order.

In HEVC and WVC, a CRA picture may be the first picture in the bitstream in decoding order, or may appear later in the bitstream. CRA pictures allow so-called leading pictures that follow the CRA picture in decoding order but precede it in output order. Some of the leading pictures, so-called RASL pictures, may use pictures decoded before the CRA picture (in decoding order) as a reference. Pictures that follow a CRA picture in both decoding and output order are decodable if random access is performed at the CRA picture, and hence clean random access is achieved similarly to the clean random access functionality of an IDR picture.

A CRA picture may have associated RADL or RASL pictures. When a CRA picture is the first picture in the bitstream in decoding order, the CRA picture is the first picture of a coded video sequence in decoding order, and any associated RASL pictures are not output by the decoder and may not be decodable, as they may contain references to pictures that are not present in the bitstream.

A leading picture is a picture that precedes the associated RAP picture in output order and follows the associated RAP picture in decoding order. The associated RAP picture is the previous RAP picture in decoding order (if present). In some coding specifications, such as HEVC and VVC, a leading picture is either a RADL picture or a RASL picture.

All RASL pictures are leading pictures of an associated IRAP picture (e.g., CRA picture). When the associated RAP picture is the first coded picture in the coded video sequence or in the bitstream, the RASL picture is not output and may not be correctly decodable, as the RASL picture may contain references to pictures that are not present in the bitstream. However, a RASL picture can be correctly decoded if the decoding had started from a RAP picture before the associated RAP picture of the RASL picture. RASL pictures are not used as reference pictures for the decoding process of non-RASL pictures. When present, all RASL pictures precede, in decoding order, all trailing pictures of the same associated RAP picture.

All RADL pictures are leading pictures. RADL pictures are not used as reference pictures for the decoding process of trailing pictures of the same associated RAP picture. When present, all RADL pictures precede, in decoding order, all trailing pictures of the same associated RAP picture. RADL pictures do not refer to any picture preceding the associated RAP picture in decoding order and can therefore be correctly decoded when the decoding starts from the associated RAP picture.

Two IDR picture types may be defined and indicated: IDR pictures without leading pictures and IDR pictures that may have associated decodable leading pictures (i.e., RADL pictures).

A trailing picture may be defined as a picture that follows the associated RAP picture in output order (and also in decoding order). Additionally, a trailing picture may be required not to be classified as any other picture type, such as STSA picture.

Some coding standards or specifications may indicate a picture type in a picture header or a frame header or alike.

Some codecs use a concept of picture order count (POC). A value of POC is derived for each picture and is non-decreasing with increasing picture position in output order. POC therefore indicates the output order of pictures. POC may be used in the decoding process for example for implicit scaling of motion vectors and for reference picture list initialization. Furthermore, POC may be used in the verification of output order conformance.

A partitioning may be defined as a division of a set into subsets such that each element of the set is in exactly one of the subsets.

In VVC, the samples are processed in units of coding tree blocks (CTB). The array size for each luma CTB in both width and height is CtbSizeY in units of samples. An encoder may select CtbSizeY on a sequence basis from values supported in the VVC standard (32, 64, 128), or the encoder may be configured to use a certain CtbSizeY value. The width and height of the array for each chroma CTB are CtbWidthC and CtbHeightC, respectively, in units of samples.

Each CTB is assigned a partition signalling to identify the block sizes for intra or inter prediction and for transform coding. The partitioning is a recursive quadtree partitioning. The root of the quadtree is associated with the CTB. The quadtree is split until a leaf is reached, which is referred to as the quadtree leaf. When the component width is not an integer number of the CTB size, the CTBs at the right component boundary are incomplete. When the component height is not an integer multiple of the CTB size, the CTBs at the bottom component boundary are incomplete.

The coding block is the root node of two trees, the prediction tree and the transform tree. The prediction tree specifies the position and size of prediction blocks. The transform tree specifies the position and size of transform blocks. The splitting information for luma and chroma is identical for the prediction tree and may or may not be identical for the transform tree.

The blocks and associated syntax structures are grouped into “unit” structures as follows:
One transform block (monochrome picture) or three transform blocks (luma and chroma components of a picture in 4:2:0, 4:2:2 or 4:4:4 colour format) and the associated transform syntax structures units are associated with a transform unit.
One coding block (monochrome picture) or three coding blocks (luma and chroma), the associated coding syntax structures and the associated transform units are associated with a coding unit.
One CTB (monochrome picture) or three CTBs (luma and chroma), the associated coding tree syntax structures and the associated coding units are associated with a coding tree unit (CTU).

A superblock in AV1 is similar to a CTU in VVC. A superblock may be regarded as the largest coding block that the AV1 specification supports. The size of the superblock is signalled in the sequence header to be 128×128 or 64×64 luma samples. A superblock may be partitioned into smaller coding blocks recursively. A coding block may have its own prediction and transform modes, independent of those of the other coding blocks.

In the following, partitioning a picture into subpictures, slices, and tiles according to H.266/VVC is described more in detail. Similar concepts may apply in other video coding specifications too.

A picture is divided into one or more tile rows and one or more tile columns. A tile is a sequence of coding tree units (CTU) that covers a rectangular region of a picture. The CTUs in a tile are scanned in raster scan order within that tile.

A slice consists of an integer number of complete tiles or an integer number of consecutive complete CTU rows within a tile of a picture. Consequently, each vertical slice boundary is always also a vertical tile boundary. It is possible that a horizontal boundary of a slice is not a tile boundary but consists of horizontal CTU boundaries within a tile; this occurs when a tile is split into multiple rectangular slices, each of which consists of an integer number of consecutive complete CTU rows within the tile.

Two modes of slices are supported, namely the raster-scan slice mode and the rectangular slice mode. In the raster-scan slice mode, a slice contains a sequence of complete tiles in a tile raster scan of a picture. In the rectangular slice mode, a slice contains either a number of complete tiles that collectively form a rectangular region of the picture or a number of consecutive complete CTU rows of one tile that collectively form a rectangular region of the picture. Tiles within a rectangular slice are scanned in tile raster scan order within the rectangular region corresponding to that slice.

A subpicture may be defined as a rectangular region of one or more slices within a picture, wherein the one or more slices are complete. Thus, a subpicture consists of one or more slices that collectively cover a rectangular region of a picture. Consequently, each subpicture boundary is also always a slice boundary, and each vertical subpicture boundary is always also a vertical tile boundary. The slices of a subpicture may be required to be rectangular slices.

One or both of the following conditions may be required to be fulfilled for each subpicture and tile:
All CTUs in a subpicture belong to the same tile.
All CTUs in a tile belong to the same subpicture.

In the following, partitioning a picture into tiles and tile groups according to AV1 is described more in detail. Similar concepts may apply in other video coding specifications too.

A tile consists of an integer number of complete superblocks that collectively form a complete rectangular region of a picture. In-picture prediction across tile boundaries is disabled. The minimum tile size is one superblock, and the maximum tile size in the presently specified levels is 4096×2304 in terms of luma sample count. The picture is partitioned a tile grid into one or more tile rows and one or more tile columns. The tile grid may be signalled in the picture header to have a uniform tile size or nonuniform tile size, where in the latter case the tile row heights and tile column widths are signalled. The superblocks in a tile are scanned in raster scan order within that tile.

A tile group OBU carries one or more complete tiles. The first and last tiles of in the tile group OBU may be indicated in the tile group OBU before the coded tile data. Tiles within a tile group OBU may appear in a tile raster scan of a picture.

A Decoded Picture Buffer (DPB) may be used in the encoder and/or in the decoder. There are two reasons to buffer decoded pictures: for references in inter prediction and/or for reordering decoded pictures into output order. Since some video coding specifications provide a great deal of flexibility for both reference picture marking and output reordering, separate buffers for reference picture buffering and output picture buffering may waste memory resources. Hence, the DPB may include a unified decoded picture buffering process for reference pictures and output reordering. A decoded picture may be removed from the DPB when it is no longer used as a reference and is not needed for output.

Video coding specifications may enable the use of supplemental enhancement information (SEI) messages, metadata syntax structures, or alike. An SEI message, a metadata syntax structure, or alike may not be required for the decoding of output pictures but may assist in related process(es), such as picture output timing, post-processing of decoded pictures, rendering, error detection, error concealment, and resource reservation.

Some video coding specifications include SEI network abstraction layer (NAL) units, and some video coding specifications contain both prefix SEI NAL units and suffix SEI NAL units, where the former type can start a picture unit or alike and the latter type can end a picture unit or alike. An SEI NAL unit contains one or more SEI messages. Several SEI messages are specified in H.264/AVC, H.265/HEVC, H.266/VVC, and H.274/VSEI standards, and the user data SEI messages enable organizations and companies to specify SEI messages for their own use. The standards may contain the syntax and semantics for the specified SEI messages but a process for handling the messages in the recipient might not be defined. Consequently, encoders may be required to follow the standard specifying a SEI message when they create SEI message(s), and decoders might not be required to process SEI messages for output order conformance. One of the reasons to include the syntax and semantics of SEI messages in standards is to allow different system specifications to interpret the supplemental information identically and hence interoperate. It is intended that system specifications can require the use of particular SEI messages both in the encoding end and in the decoding end, and additionally the process for handling particular SEI messages in the recipient can be specified.

Some video coding specifications enable metadata OBUs. A metadata OBU comprises a type field, which specifies the type of metadata.

The phrase along the bitstream (e.g., indicating along the bitstream) or along a coded unit of a bitstream (e.g., indicating along a coded tile) may be used in claims and described embodiments to refer to transmission, signaling, or storage in a manner that the “out-of-band” data is associated with but not included within the bitstream or the coded unit, respectively. The phrase decoding along the bitstream or along a coded unit of a bitstream or alike may refer to decoding the referred out-of-band data (which may be obtained from out-of-band transmission, signaling, or storage) that is associated with the bitstream or the coded unit, respectively. For example, the phrase along the bitstream may be used when the bitstream is contained in a container file, such as a file conforming to the ISO Base Media File Format, and certain file metadata is stored in the file in a manner that associates the metadata to the bitstream, such as boxes in the sample entry for a track containing the bitstream, a sample group for the track containing the bitstream, or a timed metadata track associated with the track containing the bitstream.

Some video coding standards or specifications define an access unit. An access unit may comprise coded data that is associated with the same time instance. For example, an access unit may comprise a set of coded pictures that belong to different layers and are associated with the same time for output from the DPB. An access unit may additionally comprise all non-VCL NAL units or alike associated to the set of coded pictures included in the access unit. In a single-layer bitstream, an access unit may comprise a single coded picture.

In video coding standards or specifications, it may be required that a compliant bit stream must be able to be decoded by a hypothetical reference decoder that may be conceptually connected to the output of an encoder and may comprise at least a pre-decoder buffer, a decoder and an output/display unit. This virtual decoder may be known as the hypothetical reference decoder (HRD) or the video buffering verifier (VBV). The virtual decoder and buffering verifier are collectively called as hypothetical reference decoder (HRD) in this document.

Video coding standards or specifications may use variable-bitrate coding, which is caused for example by the flexibility of the encoder to select adaptively between intra and inter coding techniques for compressing video frames. To handle fluctuation in the bitrate variation of the compressed video, buffering may be used at the encoder and decoder side. Hypothetical Reference Decoder (HRD) may be regarded as a hypothetical decoder model that specifies constraints on the variability within conforming bitstreams that an encoding process may produce.

A bitstream may be considered compliant if it can be decoded by the HRD without buffer overflow or, in some cases, underflow. Buffer overflow happens if more bits are to be placed into the buffer when it is full. Buffer underflow happens if some bits are not in the buffer when said bits are to be fetched from the buffer for decoding/playback.

An HRD may comprise one or more of the following: a coded picture buffer (CPB), an instantaneous decoding process, a decoded picture buffer (DPB), and output cropping.

Buffering parameters (for CPB and/or DPB) for a bitstream may be explicitly or implicitly signaled. “Implicitly signaled” means that the default buffering parameter values according to the profile and level apply. When buffering parameters are explicitly signaled, one or more syntax elements-signaled in or along the bitstream-indicate their values, which generally must be within the limits constrained by the profile and level in use.

An HRD may be a part of an encoder or operationally connected to the output of the encoder. The buffering occupancy and possibly other information of the HRD may be used to control the encoding process. For example, if a coded data buffer in the HRD is about to overflow, the encoding bitrate may be reduced for example by increasing a quantizer step size.

The term HRD parameters may be defined to collectively refer to parameters that affect the buffering, such as coded picture buffering or decoded picture buffering.

HRD parameters may, for example, comprise buffer size(s), input bitrate(s), and/or initial delay(s). If an HRD comprises both a CPB and a DPB, HRD parameters may comprise similar parameters, such as a buffer size and an initial delay, for the CPB and the DPB. The HRD parameters may comprise for example one or more of the following:
Initial CPB arrival delay (i.e., a delay between a reference point, e.g., the start of the buffering, until the arrival of the first bit of an associated coded data unit, such as the first access unit of the bitstream).
Initial CPB removal delay
CPB removal delay specific to a unit of coded data, e.g., an access unit
Initial DPB removal delay
DPB removal delay specific to, e.g., a decoded picture or all decoded pictures of an access unit
Hypothetical scheduler parameters, such as bitrate and indication of the use of variable bitrate or constant bitrate mode
CPB size, e.g., in terms of bits or bytes
DPB size, e.g., in terms of picture storage buffers

The operation of the HRD may be controlled by HRD parameters. The HRD parameter values may be created as part of the HRD process included or operationally connected to encoding. Alternatively, HRD parameters may be generated separately from encoding, for example in an HRD verifier that processes the input bitstream with the specified HRD process and generates such HRD parameter values according to which the bitstream is conforming. Another use for an HRD verifier is to verify that a given bitstream and given HRD parameters actually result into a conforming HRD operation and output.

HRD parameters may be indicated, for example, through video usability information included in the sequence parameter set syntax structure.

Buffering and picture timing parameters may be conveyed to the HRD, in a timely manner, either in the bitstream (e.g., by non-VCL NAL units), or by out-of-band means externally from the bitstream, e.g., using a signalling mechanism, such as media parameters included in the media line of a session description formatted e.g., according to the Session Description Protocol (SDP). In some coding standards, buffering and picture timing parameters may be included in sequence parameter sets and picture parameter sets referred to in the VCL NAL units and in buffering period and picture timing SEI messages. For the purpose of counting bits in the HRD, only the appropriate bits that are actually present in the bitstream may be counted. When the content of a non-VCL NAL unit is conveyed for the application by some means other than presence within the bitstream, the representation of the content of the non-VCL NAL unit may or may not use the same syntax as would be used if the non-VCL NAL unit were in the bitstream. Buffering and picture timing parameters may also be regarded as HRD parameters.

The CPB may operate on decoding unit basis. A decoding unit may be an access unit, or it may be a subset of an access unit, such as an integer number of NAL units.

In some coding standards, the selection of the decoding unit for the CPB may be indicated by an encoder in the bitstream. For example, decoding unit SEI messages may indicate decoding units as follows: The set of NAL units associated with a decoding unit information SEI message consists, in decoding order, of the SEI NAL unit containing the decoding unit information SEI message and all subsequent NAL units in the access unit up to but not including any subsequent SEI NAL unit containing a decoding unit information SEI message. Each decoding unit may be required to include at least one VCL NAL unit. All non-VCL NAL units associated with a VCL NAL unit may be included in the decoding unit containing the VCL NAL unit.

An HRD may operate for example as follows. Data associated with decoding units that flow into the CPB according to a specified arrival schedule may be delivered by the Hypothetical Stream Scheduler (HSS). The arrival schedule may be determined by the encoder and indicated for example through picture timing SEI messages, and/or the arrival schedule may be derived for example based on a bitrate which may be indicated for example as part of HRD parameters in video usability information. The HRD parameters in video usability information may contain many sets of parameters, each for different bitrate or delivery schedule. The data associated with each decoding unit may be removed and decoded instantaneously by the instantaneous decoding process at CPB removal times. A CPB removal time may be determined for example using an initial CPB buffering delay, which may be determined by the encoder and indicated for example through a buffering period SEI message, and differential removal delays indicated for each picture for example though picture timing SEI messages. The initial arrival time (i.e., the arrival time of the first bit) of the very first decoding unit may be determined to be 0. The initial arrival time of any subsequent decoding unit may be determined to be equal to the final arrival time of the previous decoding unit. Each decoded picture is placed in the DPB. A decoded picture may be removed from the DPB at the later of the DPB output time or the time that it becomes no longer needed for inter-prediction reference. Thus, the operation of the CPB of the HRD may comprise timing of decoding unit initial arrival (when the first bit of the decoding unit enters the CPB), timing of decoding unit removal and decoding of decoding unit, whereas the operation of the DPB of the HRD may comprise removal of pictures from the DPB, picture output, and decoded picture marking and storage.

The operation of an AU-based coded picture buffering in the HRD can be described in a simplified manner as follows. It is assumed that bits arrive into the CPB at a constant arrival bitrate (when the so-called low-delay mode is not in use). Hence, coded pictures or access units are associated with initial arrival time, which indicates when the first bit of the coded picture or access unit enters the CPB. Furthermore, in the low-delay mode the coded pictures or access units are assumed to be removed instantaneously when the last bit of the coded picture or access unit is inserted into CPB and the respective decoded picture is inserted then to the DPB, thus simulating instantaneous decoding. This time is referred to as the removal time of the coded picture or access unit. The removal time of the first coded picture of the coded video sequence is typically controlled, for example by the Buffering Period Supplemental Enhancement Information (SEI) message. This so-called initial coded picture removal delay ensures that any variations of the coded bitrate, with respect to the constant bitrate used to fill in the CPB, do not cause starvation or overflow of the CPB. It is to be understood that the operation of the CPB may be somewhat more sophisticated than what described here, having for example the low-delay operation mode and the capability to operate at many different constant bitrates. Moreover, the operation of the CPB may be specified differently in different standards.

The buffering period SEI message of some video coding standards supports indicating initial buffering requirements (e.g., initial buffering delay and initial buffering delay offset parameters). The buffering period SEI message can be signaled for example at a random access picture, in which case it may indicate the initial buffering when the reception and decoding of the bitstream starts from the random access picture.

An HRD may be used to check conformance of bitstreams and decoders.

Bitstream conformance requirements of the HRD may comprise for example the following and/or alike. The CPB is required not to overflow (relative to the size which may be indicated for example within HRD parameters of video usability information) or underflow (i.e., the removal time of a decoding unit cannot be smaller than the arrival time of the last bit of that decoding unit). The number of pictures in the DPB may be required to be smaller than or equal to a certain maximum number, which may be indicated for example in the sequence parameter set. All pictures used as prediction references may be required to be present in the DPB. It may be required that the interval for outputting consecutive pictures from the DPB is not smaller than a certain minimum.

Decoder conformance requirements of the HRD may comprise for example the following and/or alike. A decoder claiming conformance to a specific profile and level may be required to decode successfully all conforming bitstreams specified for decoder conformance. There may be two types of conformance that can be claimed by a decoder: output timing conformance and output order conformance.

To check conformance of a decoder, test bitstreams conforming to the claimed profile and level may be delivered by a hypothetical stream scheduler (HSS) both to the HRD and to the decoder under test (DUT). All pictures output by the HRD may also be required to be output by the DUT and, for each picture output by the HRD, the values of all samples that are output by the DUT for the corresponding picture may also be required to be equal to the values of the samples output by the HRD.

For output timing decoder conformance, the HSS may operate, for example, with delivery schedules selected from those indicated in the HRD parameters of video usability information, or with “interpolated” delivery schedules. The same delivery schedule may be used for both the HRD and DUT. For output timing decoder conformance, the timing (relative to the delivery time of the first bit) of picture output may be required to be the same for both HRD and the DUT up to a fixed delay.

For output order decoder conformance, the HSS may deliver the bitstream to the DUT “by demand” from the DUT, meaning that the HSS delivers bits (in decoding order) only when the DUT requires more bits to proceed with its processing. The HSS may deliver the bitstream to the HRD by one of the schedules specified in the bitstream such that the bit rate and CPB size are restricted. The order of pictures output may be required to be the same for both HRD and the DUT.

An output process may be considered to be a process in which the decoder provides decoded and cropped pictures as the output of the decoding process. The output process is typically a part of video coding standards, typically as a part of the hypothetical reference decoder specification. The display process may be considered to be a process having, as its input, the cropped decoded pictures that are the output of the decoding process. The display process may process the output pictures. For example, it may include a color conversion from the color primaries, color space and/or color gamut of the output pictures to such that is suitable for displaying. For example, output pictures comprising Y, Cb, and Cr sample arrays may be converted to R, G, and B sample arrays. The pictures resulting from the processing in the display process may be referred to as pictures to be displayed. Additionally, the display process may render the pictures to be displayed on a screen or alike and/or provide the pictures to be displayed as output for a further processing step, such as storage on a mass memory. The display process is typically not specified in video coding standards.

Scalable video coding refers to coding structure where one bitstream can contain multiple representations of the content e.g., at different bitrates, resolutions, or frame rates. In these cases, the receiver can extract the desired representation depending on its characteristics (e.g., resolution that matches best the display device). Alternatively, a server or a network element can extract the portions of the bitstream to be transmitted to the receiver depending on e.g., the network characteristics or processing capabilities of the receiver.

Scalable video coding may be realized through multi-layered coding. Multi-layered coding is a concept wherein an un-encoded visual representation of a scene is, by processes such as transformation and filtering, mapped into multiple dependent or independent representations (called layers). One or more encoders are used to encode a layered visual representation. When the layers contain redundancies, the use of a single encoder can, by using inter-layer prediction techniques, encode with a significant gain in coding efficiency. Layered video coding is typically used to provide some form of scalability in services—e.g., quality scalability, spatial scalability, temporal scalability, and view scalability.

A portion of a scalable video bitstream that provides a certain decoded representation, such as a base quality video or a depth map video for a bitstream that also contains texture video and is independently decodable from other portions of the scalable video bitstream, may be referred to as an independent layer. A scalable video bitstream may comprise multiple independent layers, e.g., a texture video layer, a depth video layer, and an alpha map video layer. A portion of a scalable video bitstream that provides a certain decoded representation or enhancement, such as a quality enhancement to a particular fidelity or a resolution enhancement to a certain picture width and height in samples and requires decoding of one or more other layers (a.k.a. reference layers) in the scalable video bitstream due to inter-layer prediction may be referred to as a dependent layer or a predicted layer.

In some scenarios, a scalable bitstream includes a “base layer”, which may provide a basic representation, such as the lowest quality video available, and one or more enhancement layers. In order to improve coding efficiency for an enhancement layer, the coded representation of that layer may depend on one or more of the lower layers, i.e., inter-layer prediction may be applied. E.g., the motion and mode information of the enhancement layer can be predicted from lower layers. Similarly, the pixel data of the lower layers can be used to create prediction for the enhancement layer. The term enhancement layer may refer to enhancing one or more aspects of reference layer(s), such as quality or resolution. A portion of the bitstream that remains after removal of all enhancement layers may be referred to as the base layer.

It needs to be understood that the term layer may be conceptual, i.e., the bitstream syntax might not include signaling of layers or the signaling of layers is not in use in a scalable bitstream that conceptually comprises several layers. The term scalability layer may be used interchangeably with the term layer.

Temporal scalability may be treated differently compared to other types of scalability. A sublayer, a sub-layer, a temporal sublayer, or a temporal sub-layer may be defined to be a temporal scalable layer (or a temporal layer, TL) of a temporally scalable bitstream. Each picture of a temporally scalable bitstream may be assigned with a temporal identifier, which may be, for example, assigned to a variable TemporalId. The temporal identifier may, for example, be indicated in a NAL unit header or in an OBU extension header. TemporalId equal to 0 corresponds to the lowest temporal level. The bitstream created by excluding all coded pictures having a TemporalId greater than or equal to a selected value and including all other coded pictures remains conforming. Consequently, a picture having TemporalId equal to tid_value does not use any picture having a TemporalId greater than tid_value as a prediction reference.

Image and video codecs may use a set of filters to enhance the visual quality of the predicted visual content and can be applied either in-loop or out-of-loop, or both. In the case of in-loop filters, the filter applied on one block in the currently-encoded frame will affect the encoding of another block in the same frame and/or in another frame which is predicted from the current frame. An in-loop filter can affect the bitrate and/or the visual quality. In fact, an enhanced block will cause a smaller residual (difference between original block and predicted-and-filtered block), thus requiring less bits to be encoded. An out-of-the loop filter will be applied on a frame after it has been reconstructed, the filtered visual content won't be as a source for prediction, and thus it may only impact the visual quality of the frames that are output by the decoder.

In-loop filters in a conventional video/image encoder and decoder may comprise an adaptive loop filter (ALF). An ALF may apply block-based filter adaptation. For example, for the luma component, one among 25 filters may be selected for each 4×4 block, based on the direction and activity of local gradients, which are derived using the samples values of that 4×4 block. The ALF classification may be performed on 2×2 block units, for instance. When all of the vertical, horizontal and diagonal gradients are below a first threshold value, the block may be classified as texture (not containing edges). Otherwise, the block may be classified to contain edges, a dominant edge direction may be derived from horizontal, vertical, and diagonal gradients, and a strength of the edge (e.g., strong or weak) may be further derived from the gradient values. When a filter within a filter set has been selected based on the classification, the filtering may be performed by applying a 7×7 diamond filter, for example, to the luma component. An ALF filter set may comprise one filter for each chroma component, and a 5×5 diamond filter may be applied to the chroma components, for example. In an example, the filter coefficients use point-symmetry relative to the center point. An ALF design may comprise clipping the difference between the neighboring sample value and the current to-be-filtered sample is added, which provides adaptability related to both spatial relationship and value similarity between samples.

In an approach, ALF filter parameters are signalled in Adaptation Parameter Set (APS). For example, in one APS, up to 25 sets of luma filter coefficients and clipping value indices, and up to eight sets of chroma filter coefficients and clipping value indices could be signalled. To reduce the overhead, filter coefficients of different classification for luma component can be merged. In slice header, the identifiers of the APSs used for the current slice are signaled. In VVC slice header, up to 7 ALF APS indices can be signaled to specify the luma filter sets that are used for the current slice. The filtering process can be further controlled at coding tree block (CTB) level. A flag is signalled to indicate whether ALF is applied to a luma CTB. A filter set among 16 fixed filter sets and the filter sets from APSs selected in the slice header may be selected per each luma CTB by the encoder and may be decoded per each luma CTB by the decoder. A filter set index is signaled for a luma CTB to indicate which filter set is applied. The 16 fixed filter sets are pre-defined in the VVC standard and hardcoded in both the encoder and the decoder. The 16 fixed filter sets may be referred to as the pre-defined ALFs.

Recently, neural networks (NNs) have been used in the context of image and video compression, by following mainly two approaches.

In one approach, NNs are used to replace one or more of the components of a traditional codec such as VVC/H.266. Here, term “traditional” refers to those codecs whose components and their parameters may not be learned from data. Examples of such components are:
Additional in-loop filter, for example by having the NN as an additional in-loop filter with respect to the traditional loop filters.
Single in-loop filter, for example by having the NN replacing all traditional in-loop filters.
Intra-frame prediction.
Inter-frame prediction.
Transform and/or inverse transform.
Probability model for the arithmetic codec.
Etc.

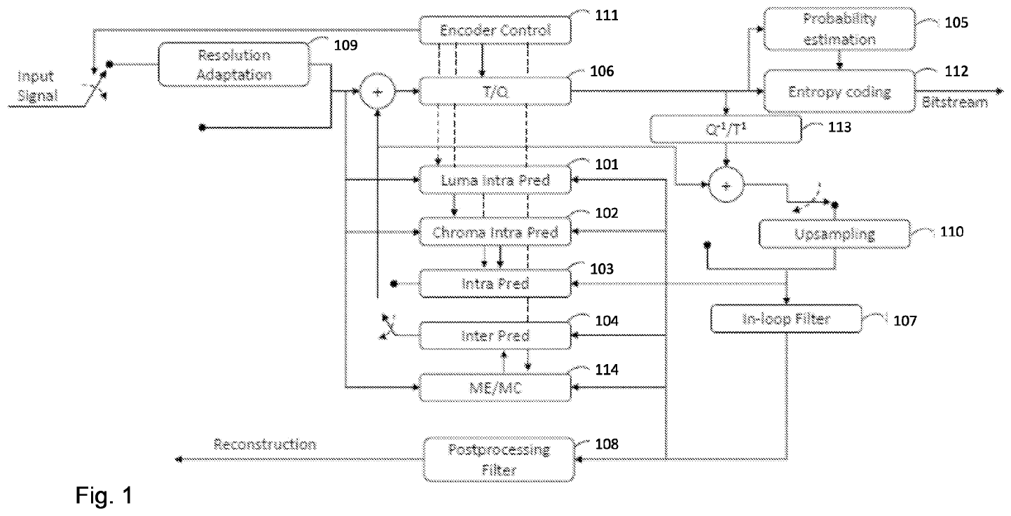

FIG. 1 illustrates examples of functioning of NNs as components of a traditional codec's pipeline, in accordance with an embodiment. In particular, FIG. 1 illustrates an encoder, which also includes a decoding loop. FIG. 1 is shown to include components described below:
A luma intra pred block or circuit 101. This block or circuit performs intra prediction in the luma domain, for example, by using already reconstructed data from the same frame. The operation of the luma intra pred block or circuit 101 may be performed by a deep neural network such as a convolutional auto-encoder.
A chroma intra pred block or circuit 102. This block or circuit performs intra prediction in the chroma domain, for example, by using already reconstructed data from the same frame. The chroma intra pred block or circuit 102 may perform cross-component prediction, for example, predicting chroma from luma. The operation of the chroma intra pred block or circuit 102 may be performed by a deep neural network such as a convolutional auto-encoder.
An intra pred block or circuit 103 and inter-pred block or circuit 104. These blocks or circuit perform intra prediction and inter-prediction, respectively. The intra pred block or circuit 103 and the inter-pred block or circuit 104 may perform the prediction on all components, for example, luma and chroma. The operations of the intra pred block or circuit 103 and inter-pred block or circuit 104 may be performed by two or more deep neural networks such as convolutional auto-encoders.
A probability estimation block or circuit 105 for entropy coding. This block or circuit performs prediction of probability for the next symbol to encode or decode, which is then provided to the entropy coding module 112, such as the arithmetic coding module, to encode or decode the next symbol. The operation of the probability estimation block or circuit 105 may be performed by a neural network.
A transform and quantization (T/Q) block or circuit 106. These are actually two blocks or circuits. The transform and quantization block or circuit 106 may perform a transform of input data to a different domain, for example, the FFT transform would transform the data to frequency domain. The transform and quantization block or circuit 106 may quantize its input values to a smaller set of possible values. In the decoding loop, there may be inverse quantization block or circuit and inverse transform block or circuit 113. One or both of the transform block or circuit and quantization block or circuit may be replaced by one or two or more neural networks. One or both of the inverse transform block or circuit and inverse quantization block or circuit 113 may be replaced by one or two or more neural networks.
An in-loop filter block or circuit 107. Operations of the in-loop filter block or circuit 107 is performed in the decoding loop, and it performs filtering on the output of the inverse transform block or circuit, or anyway on the reconstructed data, in order to enhance the reconstructed data with respect to one or more predetermined quality metrics. This filter may affect both the quality of the decoded data and the bitrate of the bitstream output by the encoder. The operation of the in-loop filter block or circuit 107 may be performed by a neural network, such as a convolutional auto-encoder. In examples, the operation of the in-loop filter may be performed by multiple steps or filters, where the one or more steps may be performed by neural networks.
A postprocessing filter block or circuit 108. The postprocessing filter block or circuit 108 may be performed only at decoder side, as it may not affect the encoding process. The postprocessing filter block or circuit 108 filters the reconstructed data output by the in-loop filter block or circuit 107, in order to enhance the reconstructed data. The postprocessing filter block or circuit 108 may be replaced by a neural network, such as a convolutional auto-encoder.
A resolution adaptation block or circuit 109: this block or circuit may downsample the input video frames, prior to encoding. Then, in the decoding loop, the reconstructed data may be upsampled, by the upsampling block or circuit 110, to the original resolution. The operation of the resolution adaptation block or circuit 109 block or circuit may be performed by a neural network such as a convolutional auto-encoder.
An encoder control block or circuit 111. This block or circuit performs optimization of encoder's parameters, such as what transform to use, what quantization parameters (QP) to use, what intra-prediction mode (out of N intra-prediction modes) to use, and the like. The operation of the encoder control block or circuit 111 may be performed by a neural network, such as a classifier convolutional network, or such as a regression convolutional network.
An ME/MC block or circuit 114 performs motion estimation and/or motion compensation, which are two key operations to be performed when performing inter-frame prediction. ME/MC stands for motion estimation/motion compensation.

In another approach, commonly referred to as “end-to-end learned compression”, NNs are used as the main components of the image/video codecs. In this second approach, there are two main options:

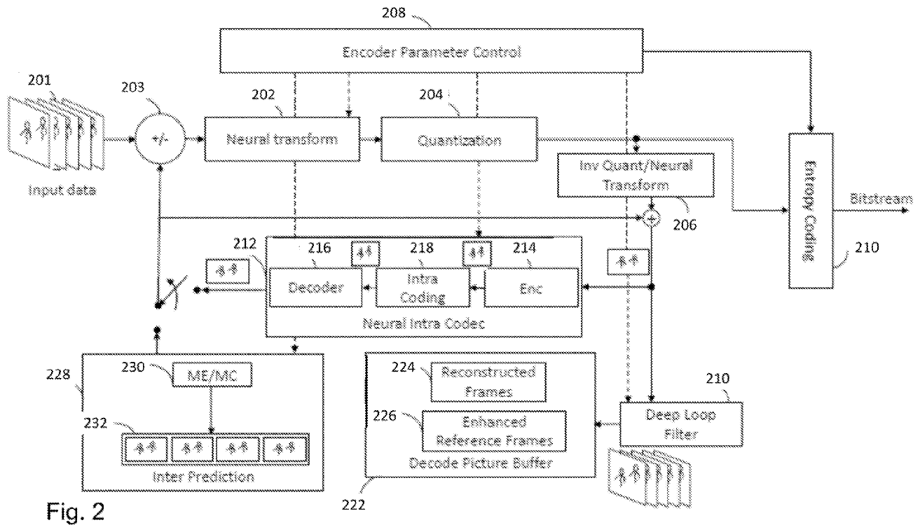

Option 1: re-use the video coding pipeline but replace most or all the components with NNs. Referring to FIG. 2, it illustrates an example of modified video coding pipeline based on a neural network, in accordance with an embodiment. An example of neural network may include, but is not limited to, a compressed representation of a neural network. FIG. 2 is shown to include following components:
A neural transform block or circuit 202: this block or circuit transforms the output of a summation/subtraction operation 203 to a new representation of that data, which may have lower entropy and thus be more compressible.
A quantization block or circuit 204: this block or circuit quantizes an input data 201 to a smaller set of possible values.
An inverse transform and inverse quantization blocks or circuits 206. These blocks or circuits perform the inverse or approximately inverse operation of the transform and the quantization, respectively.
An encoder parameter control block or circuit 208. This block or circuit may control and optimize some or all the parameters of the encoding process, such as parameters of one or more of the encoding blocks or circuits.
An entropy coding block or circuit 210. This block or circuit may perform lossless coding, for example based on entropy. One popular entropy coding technique is arithmetic coding.
A neural intra-codec block or circuit 212. This block or circuit may be an image compression and decompression block or circuit, which may be used to encode and decode an intra frame. An encoder 214 may be an encoder block or circuit, such as the neural encoder part of an auto-encoder neural network. A decoder 216 may be a decoder block or circuit, such as the neural decoder part of an auto-encoder neural network. An intra-coding block or circuit 218 may be a block or circuit performing some intermediate steps between encoder and decoder, such as quantization, entropy encoding, entropy decoding, and/or inverse quantization.
A deep loop filter block or circuit 220. This block or circuit performs filtering of reconstructed data, in order to enhance it.
A decode picture buffer block or circuit 222. This block or circuit is a memory buffer, keeping the decoded frame, for example, reconstructed frames 224 and enhanced reference frames 226 to be used for inter prediction.
An inter-prediction block or circuit 228. This block or circuit performs inter-frame prediction, for example, predicts from frames, for example, frames 232, which are temporally nearby. An ME/MC 230 performs motion estimation and/or motion compensation, which are two key operations to be performed when performing inter-frame prediction. ME/MC stands for motion estimation/motion compensation.

Option 2: re-design the whole pipeline, as follows.
Encoder NN is configured to perform a non-linear transform;
Quantization and lossless encoding of the encoder NN's output;
Lossless decoding and dequantization;
Decoder NN is configured to perform a non-linear inverse transform.

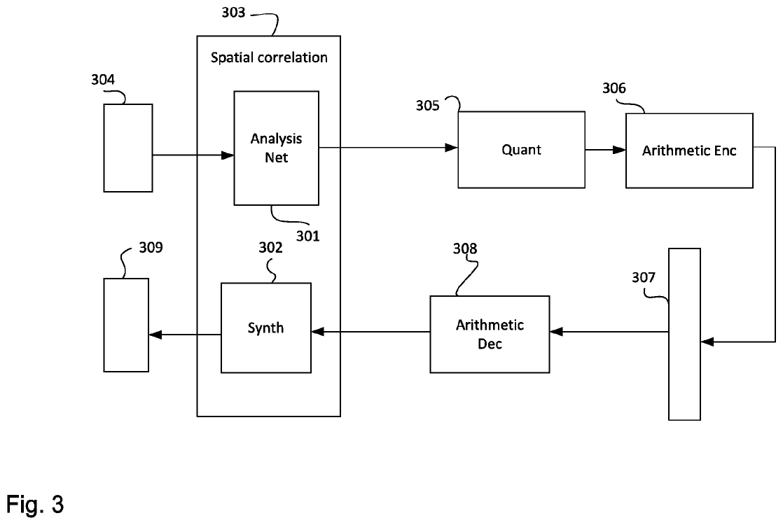

An example of option 2 is described in detail in FIG. 3 which shows an encoder NN and a decoder NN being parts of a neural auto-encoder architecture, in accordance with an example. In FIG. 3, the Analysis Network 301 is an Encoder NN, and the Synthesis Network 302 is the Decoder NN, which may together be referred to as spatial correlation tools 303, or as neural auto-encoder.

As shown in FIG. 3, the input data 304 is analyzed by the Encoder NN (Analysis Network 301), which outputs a new representation of that input data. The new representation may be more compressible. This new representation may then be quantized, by a quantizer 305, to a discrete number of values. The quantized data is then lossless encoded, for example by an arithmetic encoder 306, thus obtaining a bitstream 307. The example shown in FIG. 3 includes an arithmetic decoder 308 and an arithmetic encoder 306. The arithmetic encoder 306, or the arithmetic decoder 308, or the combination of the arithmetic encoder 306 and arithmetic decoder 308 may be referred to as arithmetic codec in some embodiments. On the decoding side, the bitstream is first lossless decoded, for example, by using the arithmetic codec decoder 308. The lossless decoded data is dequantized and then input to the Decoder NN, Synthesis Network 302. The output is the reconstructed or decoded data 309.

In case of lossy compression, the lossy steps may comprise the Encoder NN and/or the quantization.

In order to train this system, a training objective function (also called “training loss”) may be utilized, which may comprise one or more terms, or loss terms, or simply losses. In one example, the training loss comprises a reconstruction loss term and a rate loss term. The reconstruction loss encourages the system to decode data that is similar to the input data, according to some similarity metric. Examples of reconstruction losses are:
Mean squared error (MSE);
Multi-scale structural similarity (MS-SSIM);
Losses derived from the use of a pretrained neural network. For example, error (f1, f2), where f1 and f2 are the features extracted by a pretrained neural network for the input data and the decoded data, respectively, and error( ) is an error or distance function, such as L1 norm or L2 norm;
Losses derived from the use of a neural network that is trained simultaneously with the end-to-end learned codec. For example, adversarial loss can be used, which is the loss provided by a discriminator neural network that is trained adversarially with respect to the codec, following the settings proposed in the context of Generative Adversarial Networks (GANs) and their variants.

The rate loss encourages the system to compress the output of the encoding stage, such as the output of the arithmetic encoder. By “compressing”, we mean reducing the number of bits output by the encoding stage.

When an entropy-based lossless encoder is used, such as an arithmetic encoder, the rate loss typically encourages the output of the Encoder NN to have low entropy. Example of rate losses are the following:
A differentiable estimate of the entropy;
A sparsification loss, i.e., a loss that encourages the output of the Encoder NN or the output of the quantization to have many zeros. Examples are L0 norm, L1 norm, L1 norm divided by L2 norm;
A cross-entropy loss applied to the output of a probability model, where the probability model may be a NN used to estimate the probability of the next symbol to be encoded by an arithmetic encoder.

One or more of reconstruction losses may be used, and one or more of the rate losses may be used, as a weighted sum. The different loss terms may be weighted using different weights, and these weights determine how the final system performs in terms of rate-distortion loss. For example, if more weight is given to the reconstruction losses with respect to the rate losses, the system may learn to compress less but to reconstruct with higher accuracy (as measured by a metric that correlates with the reconstruction losses). These weights may be considered to be hyper-parameters of the training session and may be set manually by the person designing the training session, or automatically for example by grid search or by using additional neural networks.

It is appreciated that even in end-to-end learned approaches, there may be components which are not learned from data, such as the arithmetic codec.

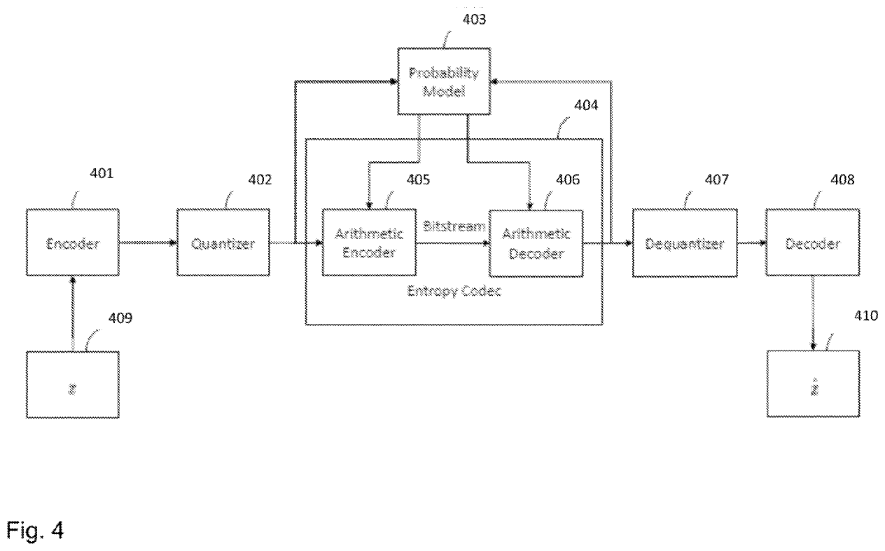

As shown in FIG. 4, a neural network-based end-to-end learned video coding system may contain an encoder 401, a quantizer 402, a probability model 403, an entropy codec 420 (for example arithmetic encoder 405/arithmetic decoder 406), a dequantizer 407, and a decoder 408. The encoder 401 and decoder 408 may be two neural networks, or mainly comprise neural network components. The probability model 403 may also comprise mainly neural network components. Quantizer 402, dequantizer 407 and entropy codec 420 may not be based on neural network components, but they may also comprise neural network components, potentially.

On the encoder side, the encoder component 401 takes a video x 409 as input and converts the video from its original signal space into a latent representation that may comprise a more compressible representation of the input. In the case of an input image, the latent representation may be a 3-dimensional tensor, where two dimensions represent the vertical and horizontal spatial dimensions, and the third dimension represent the “channels” which contain information at that specific location. If the input image is a 128×128×3 RGB image (with horizontal size of 128 pixels, vertical size of 128 pixels, and 3 channels for the Red, Green, Blue color components), and if the encoder downsamples the input tensor by 2 and expands the channel dimension to 32 channels, then the latent representation is a tensor of dimensions (or “shape”) 64×64×32 (i.e., with horizontal size of 64 elements, vertical size of 64 elements, and 32 channels). Please note that the order of the different dimensions may differ depending on the convention which is used; in some cases, for the input image, the channel dimension may be the first dimension, so for the above example, the shape of the input tensor may be represented as 3×128×128, instead of 128×128×3. In the case of an input video (instead of just an input image), another dimension in the input tensor may be used to represent temporal information.

The quantizer component 402 quantizes the latent representation into discrete values given a predefined set of quantization levels. Probability model 403 and arithmetic codec component 420 work together to perform lossless compression for the quantized latent representation and generate bitstreams to be sent to the decoder side. Given a symbol to be encoded into the bitstream, the probability model 403 estimates the probability distribution of all possible values for that symbol based on a context that is constructed from available information at the current encoding/decoding state, such as the data that has already been encoded/decoded. Then, the arithmetic encoder 405 encodes the input symbols to bitstream using the estimated probability distributions.

On the decoder side, opposite operations are performed. The arithmetic decoder 406 and the probability model 403 first decode symbols from the bitstream to recover the quantized latent representation. Then the dequantizer 407 reconstructs the latent representation in continuous values and pass it to decoder 408 to recover the input video/image. Note that the probability model 403 in this system is shared between the encoding and decoding systems. In practice, this means that a copy of the probability model 403 is used at encoder side, and another exact copy is used at decoder side.

In this system, the encoder 401, probability model 403, and decoder 408 may be based on deep neural networks. The system may be trained in an end-to-end manner by minimizing the following rate-distortion loss function:

$$L = D + λ R ,$$

where D is the distortion loss term, R is the rate loss term, and λ is the weight that controls the balance between the two losses. The distortion loss term may be the mean square error (MSE), structure similarity (SSIM) or other metrics that evaluate the quality of the reconstructed video. Multiple distortion losses may be used and integrated into D, such as a weighted sum of MSE and SSIM. The rate loss term is normally the estimated entropy of the quantized latent representation, which indicates the number of bits necessary to represent the encoded symbols, for example, bits-per-pixel (bpp).

For lossless video/image compression, the system may contain only the probability model 403 and arithmetic encoder/decoder 405, 406. The system loss function contains only the rate loss, since the distortion loss is always zero (i.e., no loss of information).

Reducing the distortion in image and video compression is often intended to increase human perceptual quality, as humans are considered to be the end users, i.e., consuming/watching the decoded image. Recently, with the advent of machine learning, especially deep learning, there is a rising number of machines (i.e., autonomous agents) that analyze data independently from humans and that may even take decisions based on the analysis results without human intervention. Examples of such analysis are object detection, scene classification, semantic segmentation, video event detection, anomaly detection, pedestrian tracking, etc. Example use cases and applications are self-driving cars, video surveillance cameras and public safety, smart sensor networks, smart TV and smart advertisement, person re-identification, smart traffic monitoring, drones, etc. When the decoded data is consumed by machines, a different quality metric shall be used instead of human perceptual quality. Also, dedicated algorithms for compressing and decompressing data for machine consumption are likely to be different than those for compressing and decompressing data for human consumption. The set of tools and concepts for compressing and decompressing data for machine consumption is referred to here as Video Coding for Machines (VCM).

VCM concerns the encoding of video streams to allow consumption for machines. Machine is referred to indicate any device except human. Example of machine can be a mobile phone, an autonomous vehicle, a robot, and such intelligent devices which may have a degree of autonomy or run an intelligent algorithm to process the decoded stream beyond reconstructing the original input stream.

A machine may perform one or multiple tasks on the decoded stream. The example of tasks can be classification, object detection and tracking, captioning, action recognition and similar objectives.

It is likely that the receiver-side device has multiple “machines” or task neural networks (Task-NNs). These multiple machines may be used in a certain combination which is for example determined by an orchestrator sub-system. The multiple machines may be used for example in succession, based on the output of the previously used machine, and/or in parallel. For example, a video which was compressed and then decompressed may be analyzed by one machine (NN) for detecting pedestrians, by another machine (another NN) for detecting cars, and by another machine (another NN) for estimating the depth of all the pixels in the frames.

In this description, “task machine” and “machine” and “task neural network” are referred to interchangeably, and for such referral any process or algorithm (learned or not from data) which analyzes or processes data for a certain task is meant. In the rest of the description, other assumptions made regarding the machines considered in this disclosure may be specified in further details.

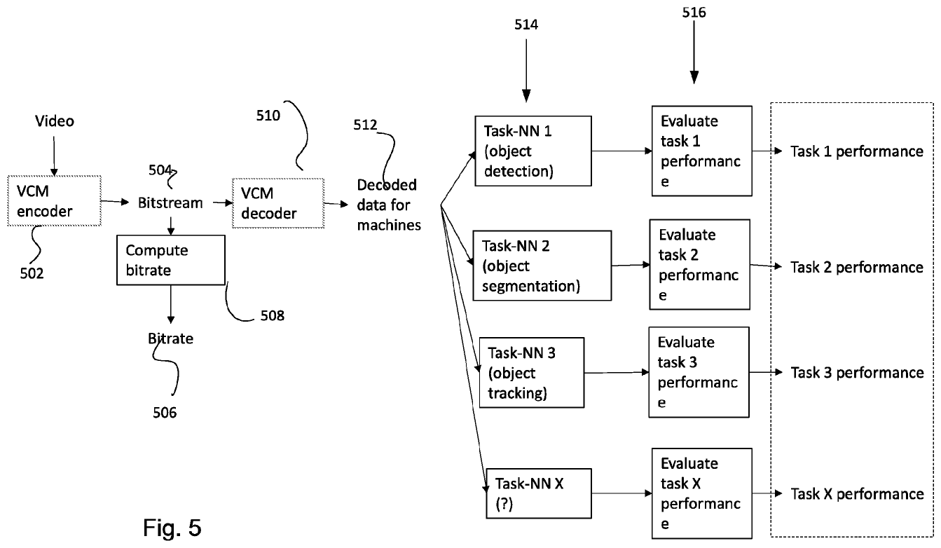

FIG. 5 is a general illustration of the pipeline of Video Coding for Machines. A VCM encoder 502 encodes the input video into a bitstream 504. A bitrate 506 may be computed 508 from the bitstream 504 in order to evaluate the size of the bitstream. A VCM decoder 510 decodes the bitstream output by the VCM encoder 502. In FIG. 5, the output of the VCM decoder 510 is referred to as “Decoded data for machines” 512. This data may be considered as the decoded or reconstructed video. However, in some implementations of this pipeline, this data may not have same or similar characteristics as the original video which was input to the VCM encoder 502. For example, this data may not be easily understandable by a human by simply rendering the data onto a screen. The output of VCM decoder is then input to one or more task neural networks 514. In the figure, for the sake of illustrating that there may be any number of task-NNs 514, there are three example task-NNs, and a non-specified one (Task-NN X). The goal of VCM is to obtain a low bitrate while guaranteeing that the task-NNs still perform well in terms of the evaluation metric 516 associated to each task.

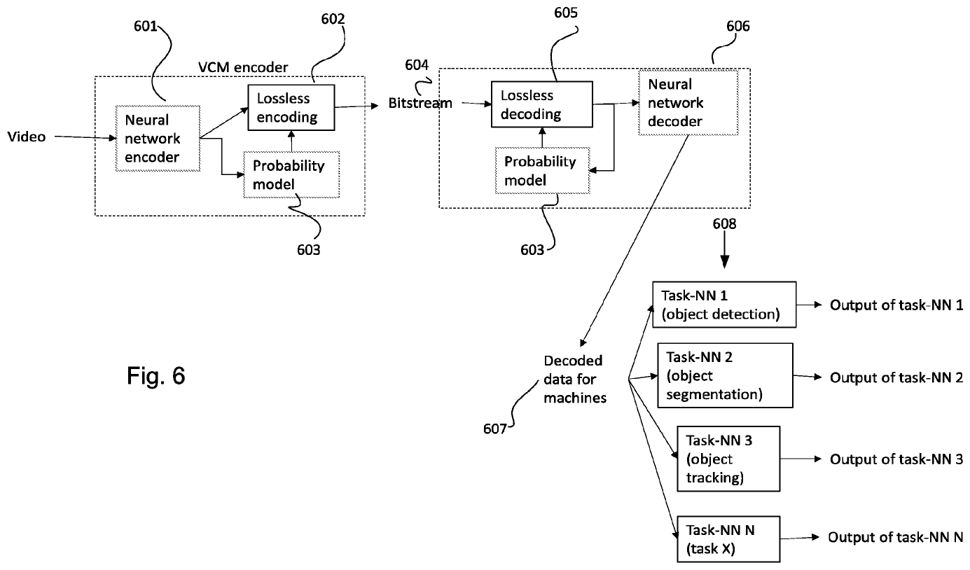

One of the possible approaches to realize video coding for machines is an end-to-end learned approach. In this approach, the VCM encoder and VCM decoder mainly consist of neural networks. FIG. 6 illustrates an example of a pipeline for the end-to-end learned approach. The video is input to a neural network encoder 601. The output of the neural network encoder 601 is input to a lossless encoder 602, such as an arithmetic encoder, which outputs a bitstream 604. The lossless codec may be a probability model 603, both in the lossless encoder and in the lossless decoder, which predicts the probability of the next symbol to be encoded and decoded. The probability model 603 may also be learned, for example it may be a neural network. At decoder-side, the bitstream 604 is input to a lossless decoder 605, such as an arithmetic decoder, whose output is input to a neural network decoder 606. The output of the neural network decoder 606 is the decoded data for machines 607, that may be input to one or more task-NNs 608.

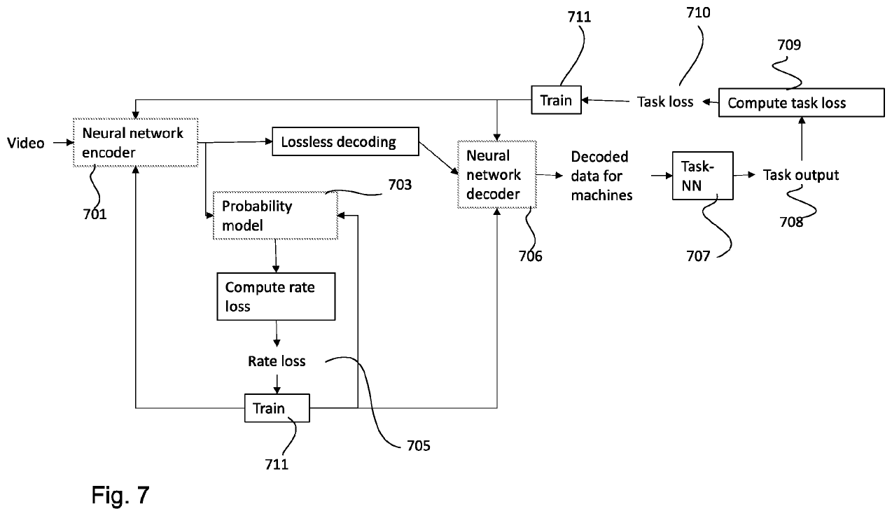

FIG. 7 illustrates an example of how the end-to-end learned system may be trained. For the sake of simplicity, only one task-NN 707 is illustrated. A rate loss 705 may be computed from the output of the probability model 703. The rate loss 705 provides an approximation of the bitrate required to encode the input video data. A task loss 710 may be computed 709 from the output 708 of the task-NN 707.

The rate loss 705 and the task loss 710 may then be used to train 711 the neural networks used in the system, such as the neural network encoder 701, the probability model 703, the neural network decoder 706. Training may be performed by first computing gradients of each loss with respect to the neural networks that are contributing or affecting the computation of that loss. The gradients are then used by an optimization method, such as Adam, for updating the trainable parameters of the neural networks.

The machine tasks may be performed at decoder side (instead of at encoder side) for multiple reasons, for example because the encoder-side device does not have the capabilities (computational, power, memory) for running the neural networks that perform these tasks, or because some aspects or the performance of the task neural networks may have changed or improved by the time that the decoder-side device needs the tasks results (e.g., different or additional semantic classes, better neural network architecture). Also, there could be a customization need, where different clients would run different neural networks for performing these machine learning tasks.

Alternatively, to an end-to-end trained codec, a video codec for machines can be realized by using a traditional codec such as H.266/VVC.

Alternatively, as described already above for the case of video coding for humans, another possible design may comprise using a traditional or conventional “base” codec, such as H.266/VVC, which additionally comprises one or more neural networks. In one possible implementation, the one or more neural networks may replace or be an alternative of one of the components of the traditional codec, such as:
one or more in-loop filters;
one or more intra-prediction modes;
one or more inter-prediction modes;
one or more transforms;
one or more inverse transforms;
one or more probability models, for lossless coding;
one or more post-processing filters.

In another possible implementation, the one or more neural networks may function as an additional component, such as:
one or more additional in-loop filters;
one or more additional intra-prediction modes;
one or more additional inter-prediction modes;
one or more additional transforms;
one or more additional inverse transforms;
one or more additional probability models, for lossless coding;
one or more additional post-processing filters.

Alternatively, another possible design may comprise using any codec architecture (such as a traditional codec, or a traditional codec which includes one or more neural networks, or an end-to-end learned codec), and having a post-processing neural network which adapts the output of the decoder so that it can be analyzed more effectively by one or more machines or task neural networks. For example, the encoder and decoder may be conformant to the H.266/VVC standard, a post-processing neural network takes the output of the decoder, and the output of the post-processing neural network is then input to an object detection neural network. In this example, the object detection neural network is the machine or task neural network.

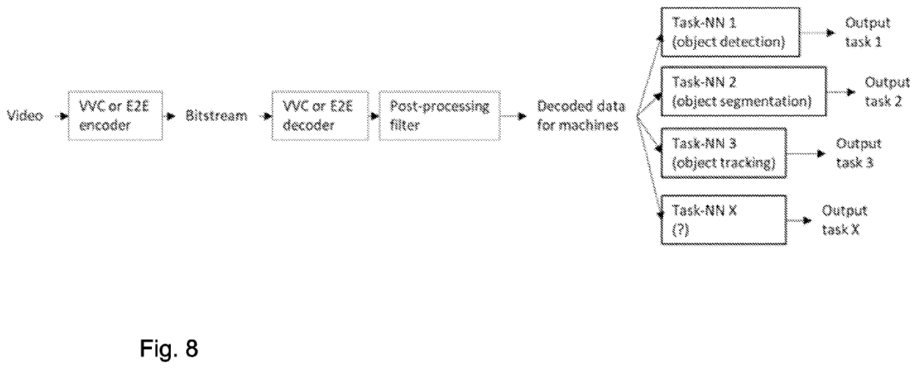

FIG. 8 illustrates an example including an encoder, a decoder, a post-processing filter, a set of task-NNs. The encoder and decoder may represent a traditional image or video codec, such as a codec conformant with the VVC/H.266 standard, or may represent an end-to-end (E2E) learned image or video codec. The post-processing filter may be a neural network-based filter. The task-NNs may be neural networks that perform tasks such as object detection, object segmentation, object tracking, etc.

Human consumption of decoded images and videos has been a primary target in the development of video coding standards and specifications, in their current form. For both human and machine consumption, end-to-end learned compression has proven to be superior to non-learned approaches (e.g., VVC) in the case of image compression, but only for restricted settings in the case of video compression, such as in some limited bitrate range or when evaluated on some specific quality metric.

A framework allowing an end-to-end learned image compression system (LIC) to be used together with a conventional video compression (CVC) codec has been introduced. In such a framework, the LIC performs intra-frame coding and the CVC performs primarily inter-frame coding, where the LIC-decoded intra frame may be used as a reference frame in a CVC codec. While the description of the framework refers to frames, it needs to be understood that it could likewise be implemented to operate on spatial units smaller than a picture, such as a subpicture, slice, tile group, tile, or block.

In this disclosure, the codec that includes at least a LIC codec and a CVC codec is referred to as “Mixed Learned and Conventional (MLC) codec”. The encoder of an MLC codec and the decoder of an MLC codec are referred to as MLC encoder and MLC decoder, respectively. Also, in the present disclosure, terms “frame” and “picture” are used interchangeably, to refer to an image, which is part of a video. For example, a video comprises a sequence of images, frames, or pictures. A frame to be intra-coded may be referred to as an intra-frame. A frame to be inter-coded may be referred to as an inter-frame.

In many of the present embodiments, a CVC encoder comprises 1) an LL-CVC codec or an LL-CVC encoder and 2) an LCVC encoder. Selected frames of the input video sequence, or data derived from selected frames of the input video sequence, are encoded with an LL-CVC codec while other frames are encoded with an LCVC encoder. Alternatively, an input interface for frames to be coded with an LL-CVC codec is separate from an input interface for frames to be coded with a LCVC encoded.

In one example, the CVC codec is a codec which is conformant with the VVC/H.266 video coding standard. LL-CVC encoder may comprise a set of algorithms that outputs a bitstream that is conformant with the VVC/H.266 video coding standard. LCVC may comprise another set of algorithms that outputs a bitstream that is conformant with the VVC/H.266 video coding standard.

An LL-CVC codec or an LL-CVC encoder refers to a first set of algorithms that encode one or more input frames. Outputs of an LL-CVC codec or an LL-CVC encoder may comprise a bitstream for the encoded frame(s) and/or decoded frame(s) corresponding to the input frame(s) and/or additional information such as partitioning information. In some embodiments, the decoded frame(s) may be referred to as LL-CVC-decoded frame(s). The bitstream or the encoded one or more frames output by the LL-CVC codec or an LL-CVC encoder may conform to the bitstream format of the CVC codec.

An LCVC encoder refers to a second set of algorithms that encode one or more input frames. A LCVC encoder may use the decoded frame(s) output by an LL-CVC codec for prediction, e.g., as reference picture(s) for inter-frame prediction.

The CVC encoder may output a bitstream that excludes coded frame(s) encoded by the LL-CVC codec and includes coded frame(s) encoded by the LCVC encoder. In another embodiment, a CVC encoder outputs all coded frame(s) (by both the LL-CVC codec and LCVC encoder) and is operationally connected to a bitstream pruner that excludes the coded frame(s) by the LL-CVC codec from the bitstream.

In the LCVC encoder, the output of the LL-CVC encoder may be used as a reference for inter-frame coding. The LCVC encoder may perform video compression and generate bitstreams representing the compressed input data. In some embodiments, the first set of algorithms, and the second set of algorithms may be the same set of algorithms. In some other embodiments, the first set of algorithms and the second set of algorithms may be different. In an example, the first set of algorithms is a set of lossless or substantially lossless coding algorithms, whereas the second set of algorithms is a set of lossy coding algorithms.

Many video coding specifications enable both lossless and lossy coding, and when such a video coding specification is in use in the CVC encoder, the LL-CVC may be a lossless or substantially lossless video or image coding algorithm conforming to the video coding specification and LCVC may be a lossy video coding algorithm conforming to the same video coding specification. In some embodiments, a CVC encoder comprises at least two logical parts, 1) an LL-CVC codec or an LL-CVC encoder and 2) an LCVC encoder, but they may share a same implementation partially or completely.

According to an embodiment, the output bitstream of a CVC encoder conforms to a bitstream format of an existing video coding specification, such as H.264/AVC, H.265/HEVC, H.266/VVC, or AV1, when both LL-CVC-encoded and LCVC-encoded frames are present in the bitstream.

The CVC specification may enable temporal syntax prediction, which may also be referred to as temporal parameter prediction, wherein syntax elements and/or syntax element values and/or variables derived from syntax elements are predicted from syntax elements of an earlier coded picture in (de) coding order and/or variables derived from a previously (de) coded picture. In an approach, the first set of algorithms (i.e., LL-CVC encoding) is not exactly specified in a video coding standard or specification, but rather the first set of algorithms is a set of lossless coding algorithms wherein any methods to determine syntax element values may be used as long as the LL-CVC-decoded frame is identical to the input frame given for encoding. Embodiments to control temporal syntax prediction from an LL-CVC-encoded frame to LCVC-encoded frames comprise:
In an embodiment, the LL-CVC encoding is constrained to encode an LL-CVC-encoded frame in a manner that temporal syntax prediction from an LL-CVC-encoded frame to any LCVC-encoded frames is implicitly turned off. For example, LL-CVC encoding may be constrained to encode the LL-CVC-encoded frame as an IRAP picture.
In an embodiment, the LCVC encoding is constrained to turn off temporal syntax prediction from an LL-CVC-encoded frame to any LCVC-encoded frames.

According to an embodiment, the MLC encoder or the CVC encoder derives and includes, in or along the output bitstream of the CVC encoder, a set of properties that the bitstream conforms to when both LL-CVC-encoded and LCVC-encoded frames are present in the output CVC bitstream. The output CVC bitstream is intended to be decoded by a CVC decoder, and thus the set of properties may characterize one or more capabilities required from the CVC decoder to decode the CVC bitstream. For example, the set of properties may be included in an SEI message or in a metadata OBU of a particular type.

The set of properties for a CVC bitstream comprising both LL-CVC-encoded and LCVC-encoded frames may comprise, but might not be limited to, one or more of the following:
A profile that the output CVC bitstream conforms to. This profile may be one of the profiles specified in the CVC standard or specification. A profile may be defined as discussed earlier in the present disclosure. For example, a profile may be defined as a subset of algorithmic features of the standard (of the encoding algorithm or the equivalent decoding algorithm).
A level value that the output CVC bitstream conforms to. A level may be defined as discussed earlier in the present disclosure. For example, a level may be defined as a set of limits to the coding parameters that impose a set of constraints in decoder resource consumption.
HRD parameters that the output CVC bitstream conforms to. HRD parameters may be defined as discussed earlier in the present disclosure.

The MLC decoder may decode, from or along a bitstream provided as input to the MLC decoder, a set of properties that the CVC bitstream conforms to when both LL-CVC-encoded and LCVC-encoded frames are present in the CVC bitstream. The MLC decoder determines based on the set of properties whether it is capable of decoding the bitstream provided as input to the MLC decoder. For example, if the CVC decoder is capable of decoding up to a particular level value of a CVC specification, but the set of properties indicates a level required for decoding that is higher than that particular level value, the MLC decoder may determine that it is not capable of decoding the bitstream provided as input to the MLC decoder.

The MLC decoder may parse, from or along a bitstream provided as input to the MLC decoder, a set of properties that the CVC bitstream conforms to when both LL-CVC-encoded and LCVC-encoded frames are present in the CVC bitstream. The MLC decoder rewrites the set of properties to the CVC bitstream. For example, the set of properties may be contained in an SEI message or metadata within the bitstream provided as input to the MLC decoder, and the MLC decoder may rewrite the set of properties to appear in DCI, VPS, and/or SPS NAL units or sequence headers in the CVC bitstream.

The LIC codec may be operationally connected to a CVC encoder. The LIC codec may encode intra frames, i.e., frames that are coded independently of other frames. An output of a LIC decoder, i.e., a LIC-decoded intra frame, is input to be encoded by an LL-CVC codec.

The MLC encoder may create a bitstream that comprises the bitstream output by the LIC encoder, and the bitstream or a part of the bitstream output by the LCVC encoder.

The CVC encoder may perform lossy intra-frame encoding. A signaling and switching mechanism is proposed, whereby the encoder may decide whether intra-frame encoding shall be performed by the LIC encoder or by the CVC encoder, for a certain intra frame, and indicates the result of the decision in or along the bitstream, e.g., to the decoder.

An output of a LIC (de) coder, i.e., a LIC-decoded intra frame or a first coded frame, is input to a first set of algorithms that are part of a CVC encoder. This set may be called “LL-CVC encoder”. Outputs of a LL-CVC encoder comprise a decoded intra frame and may comprise also additional information such as partitioning information. An output of the LL-CVC encoder, i.e., at least an LL-CVC-decoded intra frame, is input to a second set of coding algorithms that are part of a CVC encoder, referred to as a LCVC encoder, where it may be used for inter-frame coding purposes to result in a second coded frame. The LCVC encoder may perform lossy compression. The first set of algorithms and the second set of algorithms may be the same set of algorithms, or they may be different. For example, the first set of algorithms may be a set of lossless coding algorithms, whereas the second set of algorithms may be a set of lossy coding algorithms.

In an embodiment, the bitstream output by the LIC encoder and the bitstream output by the LCVC encoder are multiplexed or combined into a transmitted bitstream. In other words, the transmitted bitstream comprises the bitstream output by the LIC encoder, and the bitstream output by the LCVC encoder. There may be combiner component (or multiplexer, or mux) as part of the MLC encoder, which combines the bitstream output by a LIC encoder and the bitstream output by a LCVC encoder.

The combination operation performed by the combiner may comprise a concatenation of the two bitstreams, where the resulting bitstream includes the bitstream output by a LIC encoder followed by the bitstream output by a LCVC encoder, or the other way around. A concatenation may be performed for each pair of a LIC-encoded intra frame and a sequence of one or more LCVC-encoded inter frames predicted, where one or more of the one or more LCVC-encoded inter frame may be predicted based at least on the LIC-encoded intra frame.

According to an embodiment, a combiner is used to combine the bitstream output by a LIC encoder and the bitstream output by a LCVC encoder. An MLC encoder may comprise the combiner, or an input of the combiner may be operationally connected to the output of an MLC encoder. In an embodiment in which a CVC encoder outputs all coded frame(s) (by both the LL-CVC codec and LCVC encoder), the combiner excludes the coded frame(s) by the LL-CVC codec from the bitstream.

In an embodiment, the bitstream output by the LIC encoder and the bitstream output by the LCVC encoder are transmitted as separate bitstreams associated with each other.

In an embodiment, a received bitstream comprising the bitstream output by the LIC encoder and the bitstream output by the LCVC encoder is demultiplexed or separated into one or more bitstreams for LIC-encoded intra frames and one or more bitstreams for LCVC-encoded inter frames. There may be separator component (or demultiplexer, or demux) as part of the MLC decoder, which separates the received bitstream into one or more bitstreams for LIC-encoded intra frames and one or more bitstreams for LCVC-encoded inter frames.

In an embodiment, the MLC decoder receives the bitstream output by the LIC encoder and the bitstream output by the LCVC encoder as separate bitstreams associated with each other.

According to an embodiment, the output of the LIC decoder is filtered by one or more filters before providing it to LL-CVC encoder. In case the one or more filters are learned, a set of possible ground-truth data types that may be used for the training process are described herein.

According to an embodiment, the frames to be inter-coded by a CVC encoder (i.e., input frames to LCVC encoding) are filtered, for example by using a LIC codec or one or more operations of a LIC codec.

According to an embodiment, a CVC decoder conforms to an existing video decoding specification, such as H.264/AVC, H.265/HEVC, H.266/VVC, or AV1.

According to an embodiment, some of the components of a CVC decoder may be modified (i.e., replaced or augmented) in relation to an existing video decoding specification, such as H.264/AVC, H.265/HEVC, H.266/VVC, or AV1. For example, an in-loop filter may be added or may replace an existing in-loop filter.

Likewise, according to an embodiment, a CVC encoder may involve components that produce bitstream that are suitable for the modified components in a CVC decoder, e.g., an additional or replacement in-loop filter.

According to an embodiment, a CVC encoder and/or a CVC decoder may include one or more NN components, such as NN in-loop filters, NN transforms, end-to-end learned compression of residual, etc.

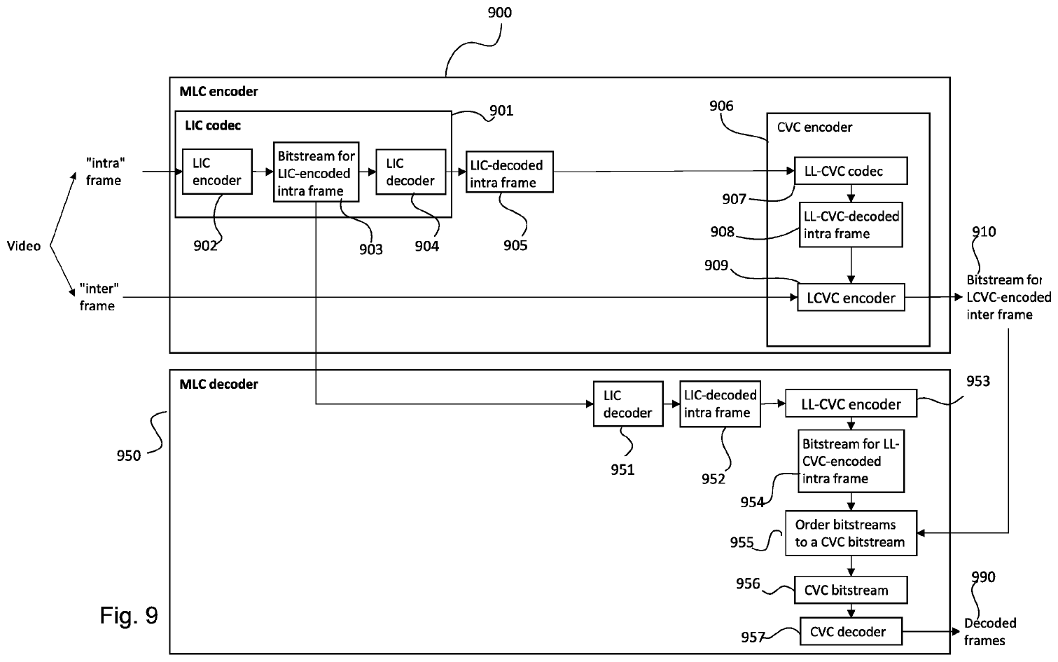

FIG. 9 illustrates a framework that realizes various aspects discussed above.

In the MLC encoder 900, the intra frame is encoded and decoded by the LIC codec 901. The LIC encoder 902 gets as an input an intra frame, and outputs a bitstream representing the LIC-encoded frame 903. The LIC encoder 902 may for example comprise one or more NN encoders, one or more quantization operations, one or more probability models, and one or more arithmetic encoders. The bitstream 903 output by the LIC encoder 902 is input to the LIC decoder 904, which outputs the LIC-decoded intra frame 905, i.e., a first decoded frame. The LIC decoder 904 may comprise one or more arithmetic decoders, one or more probability models, one or more inverse quantization operations, and one or more NN decoders.

The LIC-decoded intra frame is input to a CVC encoder 906. In some cases, the CVC encoder, comprises an LL-CVC codec 907 having an LL-CVC encoder and an LL-CVC decoder, whereas when the LL-CVC encoding is such that the LL-CVC-decoded intra frame is generated as a byproduct, the CVC encoder comprises an LL-CVC encoder. Subsequently, an LL-CVC codec 907 is used to refer to both cases. The CVC encoder 906 also comprises LCVC encoding tools 909. The LL-CVC encoder comprises a set of algorithms, for lossless (or substantially lossless) and/or lossy compression, that are part of a CVC encoder 906.

In an embodiment, the LL-CVC codec 907 is configured to perform lossless or substantially lossless compression, and consequently the LIC-decoded intra frame 905 is identical or substantially identical to the respective LL-CVC-decoded intra frame 908.

In an embodiment, the LL-CVC codec 907 is configured to perform lossy compression, and consequently LIC-decoded intra frame 905 may differ from the LL-CVC-decoded intra frame 908.

When the same LL-CVC encoding process is used both in the MLC encoder 900 and the MLC decoder 950, the LIC-decoded intra frame 905 in the MLC encoder 900 is identical or substantially identical to the respective LIC-decoded intra frame 952 in the MLC decoder 950.

An LCVC encoder 909 comprises a set of coding algorithms that are part of the CVC encoder 906 and may perform lossy compression of inter-frames. Outputs of an LL-CVC codec comprise an LL-CVC decoded intra frame 908 and, in some embodiments, additional information such as partitioning information. The LL-CVC-decoded intra frame 908 may be used by LCVC encoder 909 as a reference frame for inter-frame coding purposes, for example for inter-frame prediction. One or more frames to be inter-coded are input to the LCVC encoder 909. The LCVC encoder 909 outputs a bitstream representing the LCVC-encoded inter frames 910.

In an embodiment, the LL-CVC codec 907 may skip one or more operations that are part of the coding. For example, the LL-CVC codec 907 may skip the one or more lossless compression steps such as arithmetic coding and/or the generation of bitstream.

In an embodiment, the bitstream output by the MLC encoder 900 comprises the bitstream output by the LIC encoder 902, and the bitstream output by the LCVC encoder 909. In an embodiment, the MLC encoder 900 outputs the bitstream output by the LIC encoder 902 separately from the bitstream output by the LCVC encoder 909.

In the MLC decoder 950, the bitstream output by an LIC encoder 902 is input to the LIC decoder 951. The output of the LIC decoder 951 is an LIC-decoded intra frame 952, that is used for performing LL-CVC encoding by the LL-CVC encoder 953. The output of LL-CVC encoder 953 is a bitstream representing the LL-CVC-encoded intra frame 954, which is then ordered into a CVC bitstream 955 together with the bitstream output by the LCVC encoder 909. The resulting CVC bitstream 956 is then input to a CVC decoder 957, which decodes the LL-CVC-encoded intra frame 954 and one or more LCVC-encoded inter frames 910.

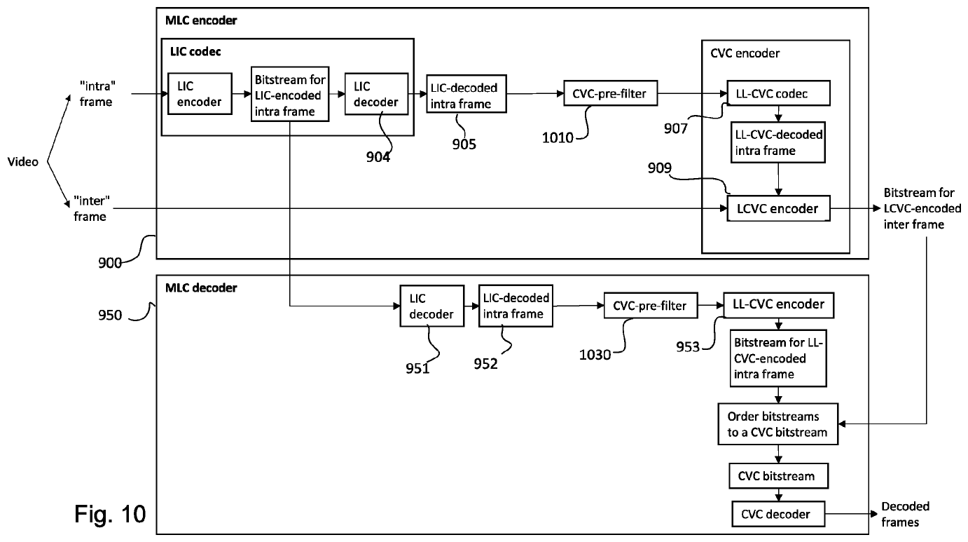

As shown in FIG. 10, the output of the LIC decoder 904 may be filtered before providing it to the LL-CVC encoding. There may be one or more filters, referred to as CVC pre-filter 1010. The filtering may modify the LIC-decoded intra frame 905 to be more similar to intra frames that are expected by LCVC encoding, i.e., more similar to the intra frames that were considered when the LCVC encoding tools were designed, where the similarity may be measured for example based on a distortion metric such as mean-squared error (MSE).

The CVC pre-filter 1010, 1030 is used both at the encoder side 900 and decoder side 905, to filter the LIC-decoded intra frame 905, 952. At encoder side 900, the output of the CVC pre-filter 1010 is input to the LL-CVC codec 907. At decoder side 950, the output of the CVC pre-filter 1030 is input to the LL-CVC encoding 953. It is to be noticed that terms “CVC pre-filter” and “CVC intra frame filter” may be used interchangeably.

Although in some of the embodiments the LIC codec 901 is end-to-end learned, the LIC codec 901 may generally be any video or image codec and have a different nature, such as one of the following:
The LIC codec 901 may be an image codec which is not end-to-end learned, for example an image codec which is not learned from data by means of machine learning techniques, or an image codec where only some components are learned from data by means of machine learning techniques.
The LIC codec 901 may be part of an end-to-end learned video codec. For example, it may be the intra-frame codec of an end-to-end learned video codec.
The LIC codec 901 may comprise both conventional and NN-based algorithms.
The LIC codec 901 may be a conventional video or image codec that conforms to a different video or image specification than the CVC encoder 906. For example, the LIC codec 901 may conform to the H.265/HEVC standard whereas the CVC encoder 906 may conform to the H.266/HEVC standard.

The current state-of-the-art video coding international standard for both human consumption and machine consumption is the Versatile Video Coding standard (H.266/VVC).

For both human and machine consumption, end-to-end learned compression has proven to be superior to non-learned approaches (e.g., VVC) in the case of image compression, but only for restricted settings in the case of video compression, such as in some limited bitrate range or when evaluated on some specific quality metric.

The CVC intra frame filters (i.e., CVC pre-filters) discussed with reference to FIG. 10 may increase the decoder's complexity and may result in additional delay for decoding the inter frames of the video sequence. The present embodiments address these issues by methods that use conventional in-loop, pre-processing and/or post-processing filters optimized for the video codec framework.

The present embodiments are targeted to an encoder, or a decoder, or a codec that comprises both an encoder and a decoder. Whenever embodiments are described with reference to the term codec, the embodiments also apply to an encoder and/or to a decoder. Whenever embodiments are described with reference to the term encoder, the embodiments also apply to a codec. Whenever embodiments are described with reference to the term decoder, the embodiments also apply to a codec. The notation “(de) coder” means an encoder and/or a decoder.

The aim of the present embodiments is to use traditional (also called “conventional”) filters in the hybrid framework as shown in FIGS. 9 and 10.

In the present solution, a video is input to the encoder, which outputs a bitstream. The bitstream is input to the decoder, which outputs a reconstructed video. The codec, comprising the encoder and the decoder, may be used for either human consumption or machine consumption or both. In case of machine consumption, the output of the decoder or data derived therefrom may be input to one or more task-NNs.

The present embodiments propose a solution for optimizing one or more parameters of one or more conventional filters, where the one or more conventional filters are used for filtering one or more LIC (de) coded frames in MLC system for enhancing the objective and/or subjective quality of the LIC-decoded images to be used as reference frame in CVC codec. Accordingly, the one or more parameters of the one or more conventional filters are derived in the encoder side based on the LIC-decoded image and uncompressed or ground truth version of the image. The optimizations may comprise, but are not necessarily limited to, one or more of the following: filter parameter derivation process, signalling, filter's mode decisions, filter's class indexes, filter's ON or OFF signalling. The terms optimize, optimization, optimized and alike, in the present embodiments generally indicate derivation of parameters, mode decisions, signalling, or alike, such as derivation of filter parameters.

In some embodiments, the optimized filter parameters and other information may be signaled in or along the traditional video bitstream (i.e., the bitstream output by the LCVC encoder). In some embodiments, the optimized filter parameters and other information may be signaled separately in or along the Mixed Learned and Conventional (MLC) codec's bitstream.

According to some embodiments, the LIC-decoded intra frame may be the output of the LIC decoder or the output of the CVC intra frame filter (i.e., CVC pre-filter).

According to some embodiments, the one or more intra frames filtered by the one or more optimized conventional filters are used as reference frames in the CVC codec, for example for predicting inter frames. In some other embodiments, the one or more intra frames filtered by the one or more optimized conventional filters are used only as output frames of the MLC decoder. In some other embodiments, the one or more intra frames filtered by the one or more optimized conventional filters are used both as reference frames in the CVC codec and as output frames of the MLC decoder.

The conventional filter (a.k.a. the traditional filter) may be one or more of the following filters or any non-neural network-based filter:
Adaptive loop filter (ALF)
Cross-component adaptive loop filter (CCALF)
Sample adaptive offset (SAO)
Cross-component sample adaptive offset (CCSAO)
Motion compensated temporal filter (MCTF)
Deblocking filter (DBF)
Bilateral filter (BF)
Constrained directional enhancement filter (CDEF)
Loop restoration filters such as Weiner and self-guided filters.

According to some embodiments, the one or more intra frames may be filtered by a combination of one or more optimized conventional filters and one or more neural network-based filters.

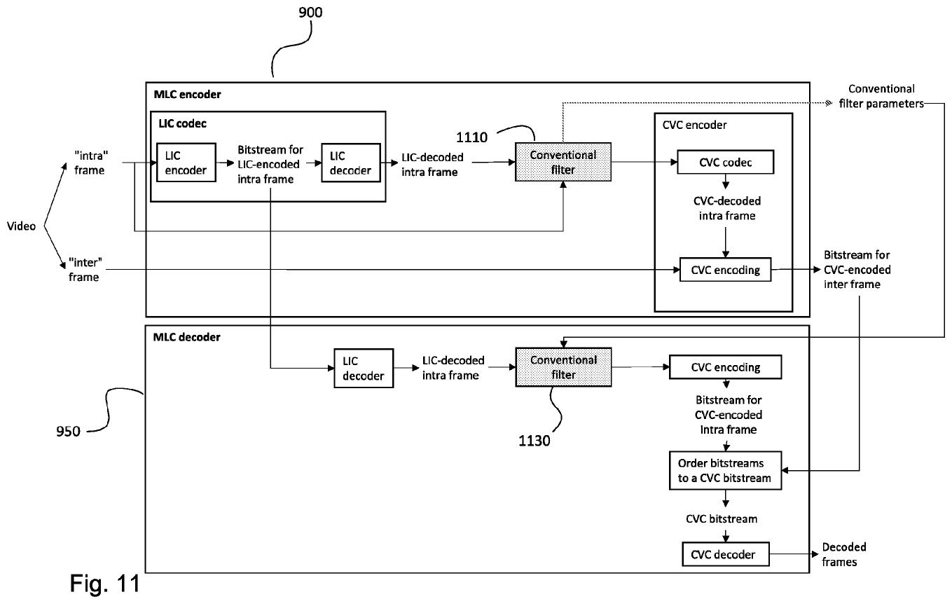

FIG. 11 illustrates an example on how the optimization of the parameters of the conventional filters are performed. It is to be noticed that the functionalities of a LIC codec and CVC encoder have been discussed with reference to FIGS. 9 and 10, and the details for FIG. 11 can be derived therefrom.

In the example of FIG. 11, the conventional filter 1110 in MLC encoder 900 receives as input the LIC-decoded content as well as uncompressed (or substantially uncompressed) or original intra frame (e.g., the intra frame that is input to the MLC encoder 900). A parameter optimization process is then conducted in order to find sets of parameters that reduce the distortion of LIC-coded content based on one or more distortion metrics or a loss function. In some embodiments, several candidate sets of parameters may be found in the parameter optimization process, and, among those, the set(s) of parameters that provides the smallest distortion or loss according to one or more distortion metrics or a loss function may be selected in the parameter optimization process. The one or more of the optimizing parameters may be signaled in or along the bitstream to the MLC decoder 950, where they can be used to optimize one or more conventional filters 1130 used to filter one or more intra frames.

According to some embodiments, one or more sets of predefined parameters for one or more conventional filters is present at encoder side 900 and at decoder side 950. The encoder 900 may signal information for identifying the set of predefined parameters to be used for one or more intra frames, or one or more portions of one or more intra frames. The encoder 900 may also signal information about how to modify one or more sets of predefined parameters, for example a correction signal.

The loss function or distortion metric may be one or more distortion losses. The one or more distortion losses may include:
Pixel-wise distortion, such as pixel-wise mean squared error (MSE) and structural similarity metric (SSIM), where the ground-truth is the uncompressed data.
Feature-element-wise distortion, such as MSE computed on feature elements, where the features are extracted from the uncompressed frames and from the compressed fames by a feature extraction operation such as a trained feature extraction NN.
Metric derived from the performance of one or more tasks applied on the compressed data, such as the cross-entropy loss of a classifier NN. Ground-truth is the labels for the considered tasks.

According to an embodiment, the MLC encoder may comprise a rate-distortion optimization (RDO) process for determining the optimized sets of parameters to be signaled.

The conventional filter(s) may have a set of pre-defined parameters available in both MLC encoder and MLC decoder. The pre-defined sets of parameters may be calculated offline using the same or different LIC-coded content.

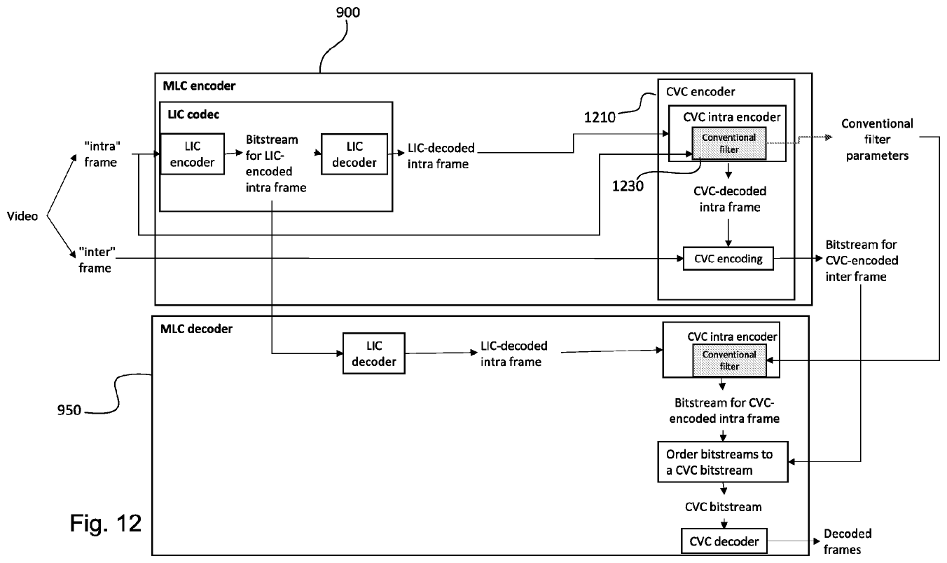

FIG. 12 illustrates another example embodiment, where the conventional filter(s) may be part of the CVC codec.

In an embodiment, conventional filter(s) are included in a CVC intra encoder, as depicted in FIG. 12.

An external reference picture may be defined as a decoded picture that is provided to a CVC (de) coder rather than decoded or reconstructed by the CVC (de) coder. Some embodiments are described below with reference to external reference picture(s). It needs to be understood that these embodiments could likewise be realized when both the LIC codec and the CVC encoder within the MLC encoder share the same decoded picture buffer, and likewise when both the LIC decoder and the CVC decoder within the MLC decoder share the same decoded picture buffer. Consequently, rather than using an external reference picture in embodiments, a particular reference picture in the decoded picture buffer may be used instead.

According to an embodiment (not depicted in FIG. 12), a CVC encoder accepts an external reference picture, the CVC intra encoder module is absent in the MLC encoder, the conventional filter(s) is present within the CVC encoder for the external reference pictures, and the LIC-decoded intra frame is provided directly to the conventional filter(s) as an external reference picture. The derivation of the optimizing parameters for the conventional filter(s) is performed according to other embodiments.

According to an embodiment (not depicted in FIG. 12), a CVC encoder accepts an external reference picture, the CVC intra encoder module is absent in the MLC encoder, the conventional filter(s) is present within the MLC encoder to derive the optimizing parameters for and to filter LIC-decoded intra frames in order to produce the external reference pictures used as reference for CVC encoding of inter frames. The derivation of the optimizing parameters for the conventional filter(s) is performed according to other embodiments.

According to an embodiment (not depicted in FIG. 12), a CVC decoder accepts an external reference picture, and the CVC intra encoder module is absent in the MLC decoder, and the CVC decoder comprises the conventional filter(s) to filter the LIC-decoded intra frames provided to the CVC decoder as external reference pictures. The usage of the optimizing parameters for the conventional filter(s) is performed according to other embodiments.

According to an embodiment (not depicted in FIG. 12), a CVC decoder accepts an external reference picture, and the CVC intra encoder module is absent in the MLC decoder, and the conventional filter(s) is present within the MLC decoder to filter LIC-decoded intra frames with the optimizing parameters in order to produce the external reference pictures used as reference for CVC decoding of inter frames. The usage of the optimizing parameters for the conventional filter(s) is performed according to other embodiments.

In an embodiment, the CVC intra encoder performs lossless or substantially lossless compression of the LIC-decoded intra frame, wherein the compression comprises or is followed by reconstructing an intermediate CVC-decoded frame prior to applying the conventional filter(s). The intermediate CVC-decoded frame is identical or substantially identical to the LIC-decoded intra frame. The CVC intra encoder applies the conventional filter(s) with the intermediate CVC-decoded frame as input to obtain the CVC-decoded intra frame.

In an embodiment (depicted in FIG. 12), the CVC encoder 1210 is modified in such a way that it uses uncompressed (or substantially uncompressed) intra frame for deriving the optimizing parameters for the conventional filter(s). The uncompressed (or substantially uncompressed) intra frame may be used as a ground truth or reference when deriving a distortion, such as the mean squared error, that is used in measuring an impact of the filtering with candidate parameters. Consequently, filtering the intermediate CVC-decoded intra frame with the conventional filter(s) using the optimizing parameters results into the CVC-decoded intra frame that resembles the uncompressed (or substantially uncompressed) intra frame.

In an embodiment (not depicted in FIG. 12), the CVC encoder 1210 additionally encodes an uncompressed (or substantially uncompressed) intra frame conventionally with the lossy CVC encoding algorithm into a secondary coded intra frame. The encoding of the secondary coded intra frame is performed using picture quality settings that makes the secondary decoded intra frame a suitable reference picture for CVC encoding of inter frames. The derivation of optimizing parameters for the conventional filter within the CVC intra encoder is modified in such a way that it uses the secondary decoded intra frame as a reference when deriving the optimizing parameters for the conventional filter(s). The secondary decoded intra frame may be used as a ground truth or reference when deriving a distortion, such as the mean squared error, that is used in measuring an impact of the filtering with candidate parameters. Consequently, filtering the intermediate CVC-decoded intra frame with the conventional filter(s) using the optimizing parameters results into the CVC-decoded intra frame that resembles the secondary decoded intra frame.

When the conventional filter 1230 is part of the CVC codec, the optimizing parameters may be derived according to the rate-distortion optimization of the CVC codec. Alternatively, the RDO of the CVC codec may use the previously described loss function as the distortion for calculating the optimizing parameters.

According to an embodiment, the conventional filter may be used in different units such as picture, slice, tile, subpicture, coding tree unit (CTU), coding unit (CU), prediction unit (PU), transform unit (TU). There may be signalling mechanism for determining the usage for each filtering unit. The signaling may comprise information such as ON/OFF, filter index, etc.

According to an embodiment, where the conventional filter is part of the CVC intra encoder in MLC decoder 950, the RDO process of filter parameter derivation in CVC encoder in MLC decoder 950 may be modified in such a way that it uses the signaled optimizing parameters instead of deriving them, as the ground truth data is not available in the MLC decoder 950. Additionally, when the filtering is applied to the LIC-decoded content in MLC decoder 950, the CVC encoder is enforced to use the signaled information related to ON/OFF and filter index is used instead of RDO-based decisions.

According to an embodiment, the conventional filter is not included or applied in the CVC intra encoder in MLC decoder 950 unlike depicted in FIG. 12. The conventional filter parameters created by the MLC encoder are included in the CVC bitstream that is constructed in the MLC decoder in a manner that the CVC decoder performs the conventional filtering with the conventional filter parameters to the CVC-encoded intra frame.

According to an embodiment, the derivation and signalling of optimized conventional filter parameters may be done for each LIC-coded frame separately.

According to an embodiment, the derivation and signaling of optimized conventional filter parameters may be done for certain intervals or sets of the LIC-coded content, for example for one LIC-coded intra frames every 10 LIC-coded intra frames. In this case, the other LIC-coded frames in that interval may use the same sets of parameters for filtering, for example for the other 9 LIC-coded intra frames in each interval of 10 frames. For a new interval, the encoder may signal information about how to modify one of the previously signaled parameters (e.g., a correction signal) in order to obtain optimizing parameters for the new interval.

According to an embodiment, the optimizing parameters are derived and signaled for the first LIC-coded frame in the video or for the first LIC-coded frame in a certain interval of frames in the video. For the remaining LIC-coded frames in the video or the certain interval, an update signaling may be used where the update may consist of difference of parameter values compared to the first or previously LIC-coded frame's parameters.

According to an embodiment, when the conventional filter consists of some sets of pre-defined parameters, the update may be done in a way that the difference between pre-defined filters and derived optimizing parameters may be signaled instead of signalling the actual optimizing parameters to MLC decoder.

According to an embodiment, there may be multiple conventional filters to be optimized for LIC-coded frames where one or more of the filters may be optimized for each LIC-coded frame. The decision on which to use may be done as part of RDO in the MLC encoder and the corresponding information related to usage and the parameters is signaled into the bitstream to MLC decoder.

According to an embodiment, when the conventional filters are part of the CVC codec, there may be a control mechanism in CVC encoder that prevents using the parameters that are derived for LIC-coded frames to be used in non-LIC-coded frames. This is important since the parameters derived for LIC-coded frames may not be optimal for non-LIC-coded frames as the characteristics of the artifacts may be different and using those parameters may decrease the performance of the CVC codec.

According to the previous embodiment, there may be a “resetting mechanism” in CVC encoder that resets the parameters derivation for the conventional filters when coding the first non-LIC-frame. Alternatively, in non-LIC frames, the parameters of the filters which are inherited from LIC-coded frames may be rewritten by identify or zero values. According to another embodiment, there are separated buffers to store the previously-derived parameters of LIC-coded and non-LIC-coded frames, which are used as references for the current LIC-coded and non-LIC-coded frames, respectively.

The LIC codec and the CVC codec may also work at block level, i.e., inputs are blocks of the intra frame, one set of outputs is the bitstreams representing the encode intra blocks, and another set of outputs is the decoded intra blocks. For each block, the RDO based decision decides which intra codec is optimal one for each block. The term block may refer to CTU, CU, PU, TU, tile, subpicture or slice.

The LIC codec and the CVC codec may work at block level within inter frames. In this case, an RDO based decision can be used to select between LIC intra coding, CVC intra coding and CVC inter coding for a block or a set of blocks. The decision can be signalled in the bitstream and decoded by a decoder to determine how to decode the block or a set of blocks.

According to an embodiment, when the LIC and CVC codecs work at block level, as described above, the conventional filter optimization may be applied to the blocks that are coded with LIC codec. Consequently, the combined LIC and CVC encoder may be modified in such a way that the conventional filter that is part of the CVC codec does not use the parameters that are derived for LIC-coded blocks. There may be separate signaling mechanisms for conventional filter used for blocks coded with LIC and CVC codecs.

According to an embodiment, the LIC decoded frame may be filtered by both NN-based CVC pre-filter and one or more of the optimized conventional filters. In an example, the final filtered LIC-decoded frame may be obtained by weighted averaging of the NN-based CVC pre-filter and optimized conventional filter. The weight values may be fixed, or they may be calculated in the MLC encoder side based on RDO and signaled to the MLC decoder in the bitstream, or they may be derived in the MLC decoder side.

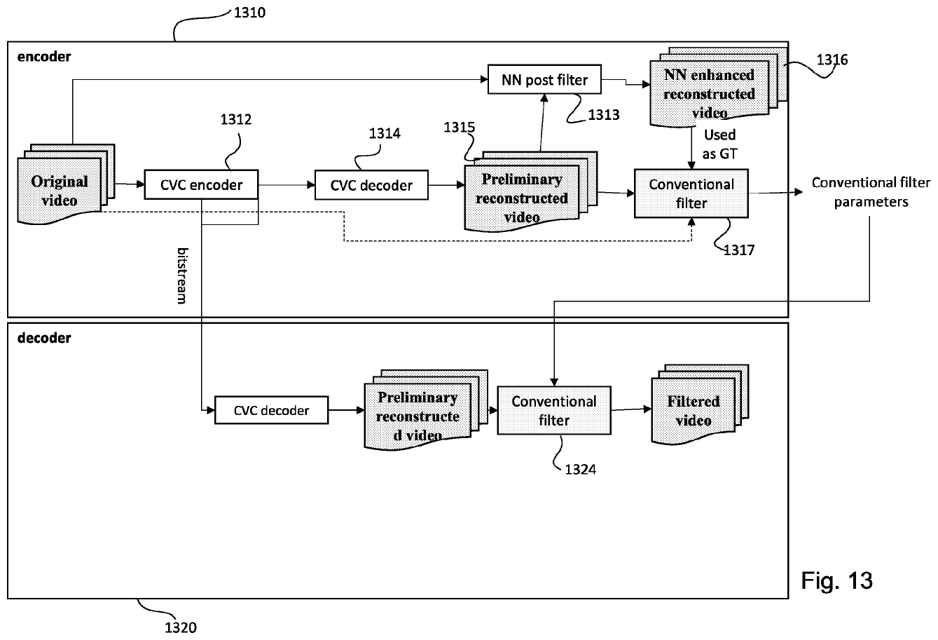

According to an embodiment, the conventional filter(s) may be optimized in a way that they are used for post-processing after CVC decoding. The optimization may be done according to the system illustrated in FIG. 13. In this example, in the encoder side 1310, the video sequence is encoded by CVC encoder 1312 and then the CVC decoder 1314 is used for decoding the bitstream in order to obtain the preliminary reconstructed frame/video 1315. A neural network-based post processing filter 1313 which is trained on a large dataset is used for filtering the preliminary video in order to get the enhanced reconstructed video 1316. The preliminary reconstructed video 1315 along with the NN enhanced reconstructed video 1316 is then passed to the conventional filtering 1317 process in order to derive the optimizing parameters for the conventional filter. The optimizing parameters are signaled in or along the MLC bitstream or in or along the CVC bitstream, e.g., the SEI or alike mechanism of the CVC codec to the decoder side 1320. This process is useful for reducing the complexity of the post-processing in decoder side by replacing the NN-based post-processing with conventional filter(s) 1324 optimized in a way that it produces same or similar results as NN-based post processing filter. According to an alternative embodiment, as the optimization does not use the uncompressed video or the video input to the MLC encoder, the optimization may be performed by the decoder side 1320, and no signaling of optimizing parameters may be needed. The optimization may be done only for one or few frames, and the conventional filter may be used as a replacement for the post-processing filter for the other frames.

The conventional filter may have a RDO process for determining the optimizing parameters in encoder side. The RDO process may use one or more of the loss functions described previously. The RDO process may use either or both NN enhanced reconstructed video or original video for the optimizations.

According to an embodiment, the conventional filter parameter optimizations and the signaling may be done in different levels such as sequence, RA segment, picture, slice, tile, subpicture, CTU and CU.

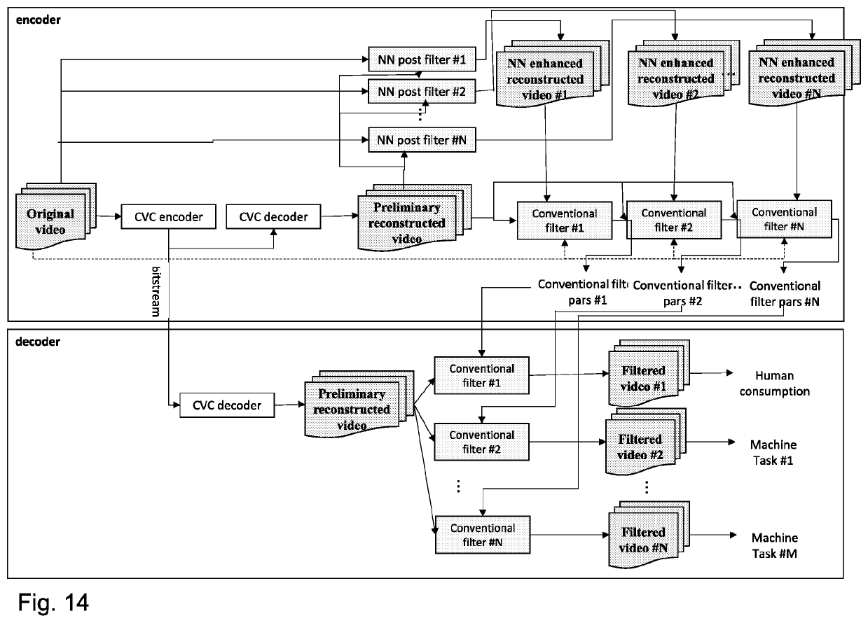

FIG. 14 illustrates an example embodiment, where there may be two or more sets of parameters, per frame or video, each targeting different post-processing purpose. For example, one set of optimizing parameters may be derived for enhancing the decoded image for human consumption and one or more sets for enhancing machine vision task enhancement purposes.

According to previous embodiment, the RDO for each conventional filter optimization may use the same or different loss functions for deriving the optimizing parameters for the conventional filter(s) depending on the task. For example, the RDO for conventional filter targeting for human consumption may use pixel-wise MSE and/or SSIM metric as loss function whereas the RDO for conventional filter targeting machine consumption may use feature domain distortion instead of or in addition to MSE and/or SSIM metrics.

### Example Embodiment with VVC and ALF

According to an embodiment, a LIC-encoded intra frame is encapsulated into one or more VCL NAL units, where the VCL NAL unit type may indicate that the NAL unit comprises LIC-encoded data. The bitstream is hence structurally formatted like a CVC bitstream while contains VCM NAL units with a new type.

In an embodiment, a LIC-encoded intra frame is encapsulated into a slice syntax structure, which comprises a slice header and slice data. In the embodiment, the slice header has syntax and semantics complying with a CVC specification, and the slice data comprises the LIC-encoded intra frame. Consequently, the slice header carries the syntax elements that may be applicable when using the LIC-decoded intra frame or the respective LL-CVC-decoded intra frame for prediction. For example, the slice header may carry syntax element(s) indicative of a picture order count value for the LIC-decoded intra frame, which may, for example, be used for identifying the LIC-decoded intra frame as a reference picture and/or scaling motion vectors that reference the LIC-decoded intra frame. It is remarked that this embodiment similarly applies to any syntax structure similar to a slice, such as a tile group syntax structure, which comprises a tile group header and coded data for the tile group.

According to an embodiment, signalling of the in-loop filter parameters of the CVC codec is used for the LIC-encoded intra frame. In an example embodiment for VVC, an encoder generates conventional filter parameters for ALF and encodes them in an ALF APS. In a respective decoder-side example embodiment, a decoder decodes an ALF APS to derive ALF parameters to be used for filtering a LIC-decoded frame.

In an embodiment, the slice or the VCL NAL unit containing the LIC-encoded data also comprises filter control information to indicate which filter(s) are in use and/or block-wise selection of filter. According to an embodiment, an encoder generates the filter control information into the slice or the VCL NAL unit containing the LIC-encoded data. In a respective embodiment for decoding, a decoder decodes filter control information from a slice or a VCL NAL unit containing the LIC-encoded data and uses the filter control information for filtering the LIC-decoded frame.

According to embodiment, a LIC-encoded intra frame occupies NAL unit type equal to 11 in a WVC bitstream and is hence treated as an IRAP picture. The RBSP syntax structure slice_nn_irap_rbsp( ) may be specified to be contained in NAL units of NAL unit type equal to 11:

| | | | |
|---|---|---|---|
| 11 | NN_IRAP | Neural network coded IRAP picture or subpicture | VCL |
| | | slice_nn_irap_rbsp( ) | |

According to an embodiment, slice_nn_irap_rbsp( ) comprises three parts:
slice header,
filter control information to turn conventional in-loop filter on/off on block basis and/or to indicate which filter to use,
LIC-encoded intra frame, which is denoted below as slice_nn_irap_data( )

Example syntax of slice_nn_irap_rbsp ( ) is as follows:

Descriptor

```
slice_nn_irap_rbsp( ) {
  slice_nn_irap_header( )
  slice_nn_irap_data( )
  slice_filter_control( )
  rbsp_slice_trailing_bits( )
}
```

Example syntax for the slice header, i.e., slice_nn_irap_header( ) is as follows:

| | Descriptor |
|---|---|
| slice_nn_irap_header( ) { | |
| sh_picture_header_in_slice_header_flag | u(1) |
| if( sh_picture_header_in_slice_header_flag ) | |
| picture_header_structure( ) | |
| if( sps_subpic_info_present_flag ) | |
| sh_subpic_id | u(v) |
| if( ( pps_rect_slice_flag && NumSlicesInSubpic[ CurrSubpicIdx ] > 1 ) ∥ | |
| ( !pps_rect_slice_flag && NumTilesInPic > 1) ) | |
| sh_slice_address | u(v) |
| for( i = 0; i < NumExtraShBits; i++ ) | |
| sh_extra_bit[ i ] | u(1) |
| sh_no_output_of_prior_pics_flag | u(1) |
| sh_nn_irap_subtype | u(2) |
| sh_nn_irap_model_idc | ue(v) |
| if( sps_alf_enabled_flag && !pps_alf_info_in_ph_flag ) { | |
| sh_alf_enabled_flag | u(1) |
| if( sh_alf_enabled_flag ) { | |
| sh_num_alf_aps_ids_luma | u(3) |
| for( i = 0; i < sh_num_alf_aps_ids_luma; i++ ) | |
| sh_alf_aps_id_luma[ i ] | u(3) |
| if( sps_chroma_format_idc != 0 ) { | |
| sh_alf_cb_enabled_flag | u(1) |
| sh_alf_cr_enabled_flag | u(1) |
| } | |
| if( sh_alf_cb_enabled_flag ∥ sh_alf_cr_enabled_flag ) | |
| sh_alf_aps_id_chroma | u(3) |
| if( sps_ccalf_enabled_flag ) { | |
| sh_alf_cc_cb_enabled_flag | u(1) |
| if( sh_alf_cc_cb_enabled_flag ) | |
| sh_alf_cc_cb_aps_id | u(3) |
| sh_alf_cc_cr_enabled_flag | u(1) |
| if( sh_alf_cc_cr_enabled_flag ) | |
| sh_alf_cc_cr_aps_id | u(3) |
| } | |
| } | |
| } | |
| if( !pps_rpl_info_in_ph_flag && | |
| ( sh_nn_irap_subtype = = 2 ∥ sps_idr_rpl_present_flag ) ) | |
| ref_pic_lists( ) | |
| if( pps_slice_header_extension_present_flag ) { | |
| sh_slice_header_extension_length | ue(v) |
| for( i = 0; i < sh_slice_header_extension length; i++) | |
| sh_slice_header_extension_data_byte[ i ] | u(8) |
| } | |
| byte_alignment( ) | |
| } | |

The semantics may be identical to the syntax elements of the same name in slice_header( ) in VVC. Additionally, the following semantics may be defined, although it needs to be understood that the example embodiment could likewise be realized without the presence of these syntax elements:
sh_nn_irap_subtype equal to 0 specifies an IDR picture or subpicture that may have associated R pictures or subpictures. sh_nn_irap_subtype equal to 1 specifies an IDR picture or subpicture without associated leading pictures or subpictures. sh_nn_irap_subtype equal to 2 specifies a CRA picture or subpicture. sh_nn_irap-subtype equal to 3 is reserved.
sh_nn_irap_model_idc specifies the neural network that is used for decoding slice_nn_irap_data( )

Example syntax for slice_filter_contro( ) is as follows:

| | Descriptor |
|---|---|
| slice_filter_control( ) { | |
| FirstCtbRowInSlice = 1 | |
| for( i = 0; i < NumCtusInCurrSlice; i++ ) { | |
| CtbAddrInRs = CtbAddrInCurrSlice[ i ] | |
| CtbAddrX = ( CtbAddrInRs % PicWidthInCtbsY ) | |
| CtbAddrY = ( CtbAddrInRs / PicWidthInCtbsY ) | |
| ctu_wise_alf_control( ) | |
| if( i = = NumCtusInCurrSlice − 1) | |
| end_of_slice_one_bit /* equal to 1 */ | ae(v) |
| } | |
| } | |

The semantics of end_of_slice_one_bit may be identical to the syntax elements of the same name in slice_data( ) of VVC.

Example syntax for ctu_wise_alf_control( ) is as follows:

| | Descriptor |
|---|---|
| ctu_wise_alf_control( ) { | |
| xCtb = CtbAddrX << CtbLog2SizeY | |
| yCtb = CtbAddrY << CtbLog2SizeY | |
| if( sh_alf_enabled_flag ){ | |
| alf_ctb_flag[ 0 ][ CtbAddrX ][ CtbAddrY ] | ae(v) |
| if( alf_ctb_flag[ 0 ][ CtbAddrX ][ CtbAddrY ] ) { | |
| if( sh_num_alf_aps_ids_luma > 0 ) | |
| alf_use_aps_flag | ae(v) |
| if( alf_use_aps_flag ) { | |
| if( sh_num_alf_aps_ids_luma > 1 ) | |
| alf_luma_prev_filter_idx | ae(v) |
| } else | |
| alf_luma_fixed_filter_idx | ae(v) |
| } | |
| if( sh_alf_cb_enabled_flag ) { | |
| alf_ctb_flag[ 1 ][ CtbAddrX ][ CtbAddrY ] | ae(v) |
| if( alf_ctb_flag[ 1 ][ CtbAddrX ][ CtbAddrY ] | |
| && alf_chroma_num_alt_filters_minus1 > 0 ) | |
| alf_ctb_filter_alt_idx[ 0 ][ CtbAddrX ][ CtbAddrY ] | ae(v) |
| } | |
| if( sh_alf_cr_enabled_flag ){ | |
| alf_ctb_flag[ 2 ][ CtbAddrX ][ CtbAddrY ] | ae(v) |
| if( alf_ctb_flag[ 2 ][ CtbAddrX ][ CtbAddrY ] | |
| && alf_chroma_num_alt_filters_minus1 > 0 ) | |
| alf_ctb_filter_alt_idx[ 1 ][ CtbAddrX ][ CtbAddrY ] | ae(v) |
| } | |
| } | |
| if( sh_alf_cc_cb_enabled_flag ) | |
| alf_ctb_cc_cb_idc[ CtbAddrX ][ CtbAddrY ] | ae(v) |
| if( sh_alf_cc_cr_enabled_flag ) | |
| alf_ctb_cc_cr_idc[ CtbAddrX ][ CtbAddrY ] | ae(v) |
| } | |

The semantics may be identical to the syntax elements of the same name in coding_tree_unit( ) in VVC.

According to an embodiment, an MLC decoder includes the ALF APSs referenced by the VCL NAL units containing LIC-encoded data into the CVC bitstream. The MLC decoder also parses the ALF information of slice_nn_irap_header( ) and slice_filter_control( ) and rewrites the parsed information into slice_header( ) and slice_data( ) respectively, of the CVC-encoded intra frame. Moreover, the MLC decoder parses ctu_wise_filter_control( ) within slice_filter_control( ) and rewrites the parsed information into the respective coding_tree_unit( ) of slice_data( )

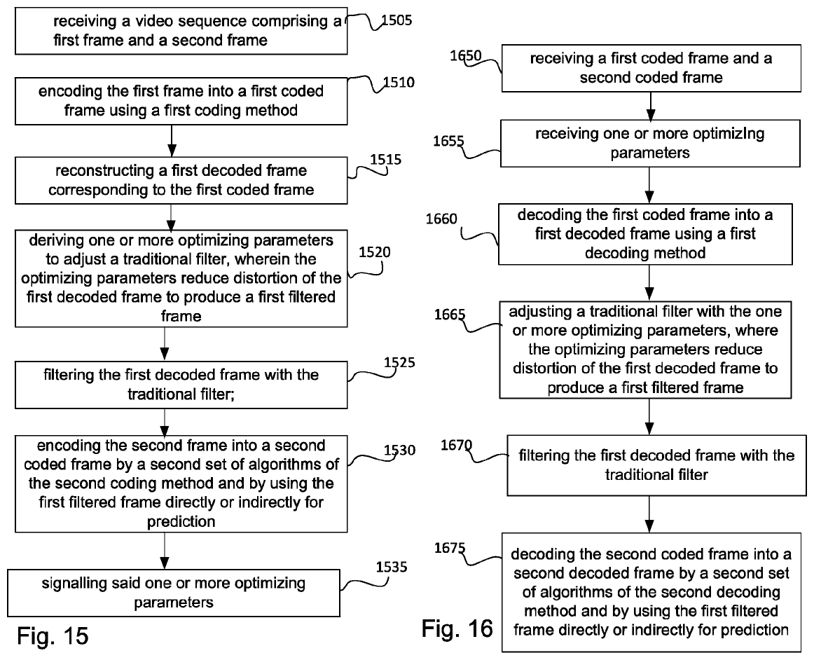

The method for encoding according to an embodiment is shown in FIG. 15. The method generally comprises receiving 1505 a video sequence comprising a first frame and a second frame; encoding 1510 the first frame into a first coded frame using a first coding method; reconstructing 1515 a first decoded frame corresponding to the first coded frame; deriving 1520 one or more optimizing parameters to adjust a traditional filter, wherein the optimizing parameters reduce distortion of the first decoded frame to produce a first filtered frame; filtering 1525 the first decoded frame with the traditional filter; encoding 1530 the second frame into a second coded frame by a second set of algorithms of the second coding method and by using the first filtered frame directly or indirectly for prediction; and signalling 1535 said one or more optimizing parameters. Each of the steps can be implemented by a respective module of a computer system.

An apparatus according to an embodiment comprises means for receiving a video sequence comprising a first frame and a second frame; means for encoding the first frame into a first coded frame using a first coding method; means for reconstructing a first decoded frame corresponding to the first coded frame; means for deriving one or more optimizing parameters to adjust a traditional filter, wherein the optimizing parameters reduce distortion of the first decoded frame to produce a first filtered frame; means for filtering the first decoded frame with the traditional filter; means for encoding the second frame into a second coded frame by a second set of algorithms of the second coding method and by using the first filtered frame directly or indirectly for prediction; and means for signalling said one or more optimizing parameters. The means comprises at least one processor, and a memory including a computer program code, wherein the processor may further comprise processor circuitry. The memory and the computer program code are configured to, with the at least one processor, cause the apparatus to perform the method of FIG. 15 according to various embodiments.

The method for decoding according to an embodiment is shown in FIG. 16. The method generally comprises receiving 1650 a first coded frame and a second coded frame; receiving 1655 one or more optimizing parameters; decoding 1660 the first coded frame into a first decoded frame using a first decoding method; adjusting 1665 a traditional filter with the one or more optimizing parameters, where the optimizing parameters reduce distortion of the first decoded frame to produce a first filtered frame; filtering 1670 the first decoded frame with the traditional filter; decoding 1675 the second coded frame into a second decoded frame by a second set of algorithms of the second decoding method and by using the first filtered frame directly or indirectly for prediction. Each of the steps can be implemented by a respective module of a computer system.

An apparatus according to an embodiment comprises means for receiving a first coded frame and a second coded frame; means for receiving one or more optimizing parameters; means for decoding the first coded frame into a first decoded frame using a first decoding method; means for adjusting a traditional filter with the one or more optimizing parameters, where the optimizing parameters reduce distortion of the first decoded frame to produce a first filtered frame; means for filtering the first decoded frame with the traditional filter; means for decoding the second coded frame into a second decoded frame by a second set of algorithms of the second decoding method and by using the first filtered frame directly or indirectly for prediction. The means comprises at least one processor, and a memory including a computer program code, wherein the processor may further comprise processor circuitry. The memory and the computer program code are configured to, with the at least one processor, cause the apparatus to perform the method of FIG. 16 according to various embodiments.

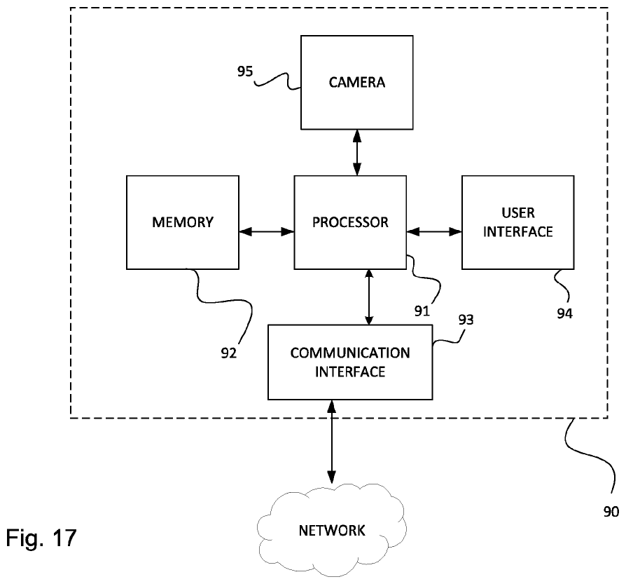

An example of an apparatus is shown in FIG. 17. The apparatus is a user equipment for the purposes of the present embodiments. The apparatus 90 comprises a main processing unit 91, a memory 92, a user interface 94, a communication interface 93. The apparatus according to an embodiment, shown in FIG. 17, may also comprise a camera module 95. Alternatively, the apparatus may be configured to receive image and/or video data from an external camera device over a communication network. The memory 92 stores data including computer program code in the apparatus 90. The computer program code is configured to implement the method according to various embodiments by means of various computer modules. The camera module 95 or the communication interface 93 receives data, in the form of images or video stream, to be processed by the processor 91. The communication interface 93 forwards processed data, i.e., the image file, for example to a display of another device, such a virtual reality headset. When the apparatus 90 is a video source comprising the camera module 95, user inputs may be received from the user interface.

Many embodiments have been described with reference to complete frames, such as a LIC-encoded intra frame and a LIC-decoded intra frame. It needs to be understood that embodiments could be similarly realized when (de) coding takes place at spatial units that are a subset of a frame and may, for example, be similar to a subpicture, slice, tile group or tile in some video coding standards or specifications. Such units can be separately processed in LIC encoding, LIC decoding, LL-CVC encoding, LL-CVC decoding, encapsulation into a bitstream, and/or parsing from a bitstream.

Some embodiments have been described with reference to concepts, such as slice, tile, subpicture, coding tree unit (CTU), coding unit (CU), prediction unit (PU), transform unit (TU). It needs to be understood that while such concepts may apply only to some video coding standards or specifications, the embodiments generally apply to any similar concepts. For example, a slice may correspond to a tile group in some video coding specifications, and a CTU may correspond to a superblock in some video coding specifications.

Many embodiments have been described with reference to a LIC codec. It needs to be understood that embodiments could be similarly realized with any video or image codec in the place of the LIC codec, which may or may not be based on neural networks.

The various embodiments can be implemented with the help of computer program code that resides in a memory and causes the relevant apparatuses to carry out the method. For example, a device may comprise circuitry and electronics for handling, receiving and transmitting data, computer program code in a memory, and a processor that, when running the computer program code, causes the device to carry out the features of an embodiment. Yet further, a network device like a server may comprise circuitry and electronics for handling, receiving, and transmitting data, computer program code in a memory, and a processor that, when running the computer program code, causes the network device to carry out the features of various embodiments.

If desired, the different functions discussed herein may be performed in a different order and/or concurrently with other. Furthermore, if desired, one or more of the above-described functions and embodiments may be optional or may be combined.

Although various aspects of the embodiments are set out in the independent claims, other aspects comprise other combinations of features from the described embodiments and/or the dependent claims with the features of the independent claims, and not solely the combinations explicitly set out in the claims.

It is also noted herein that while the above describes example embodiments, these descriptions should not be viewed in a limiting sense. Rather, there are several variations and modifications, which may be made without departing from the scope of the present disclosure as, defined in the appended claims.

1-16. (canceled)

17. An apparatus for encoding comprising: at least one processor; and at least one memory including computer program code; wherein the at least one memory and the computer program code are configured to, with the at least one processor, cause the apparatus at least to:
receive a video sequence comprising a first frame and a second frame;
encode the first frame into a first coded frame using a first coding method;
reconstruct a first decoded frame corresponding to the first coded frame;
derive one or more optimizing parameters to adjust a filter, wherein said one or more optimizing parameters reduce distortion of the first decoded frame to produce a first filtered frame;
filter the first decoded frame with the filter;
encode the second frame into a second coded frame by a second set of algorithms of a second coding method and by using the first filtered frame directly or indirectly for prediction; and
signal said one or more optimizing parameters.

18. An apparatus according to claim 17, wherein the apparatus is further caused to:
encode the first decoded frame by a first set of algorithms of the second coding method,
wherein to encode the first decoded frame, the apparatus is further caused to:
reconstruct another first decoded frame; and
filter the another first decoded frame with the filter using said one or more optimizing parameters into another first decoded and filtered frame, wherein the another first decoded and filtered frame is used directly for prediction of the second frame.

19. An apparatus according to claim 17, wherein to derive said one or more optimizing parameters, the apparatus is further caused to: derive the distortion in relation to the first frame.

20. An apparatus according to claim 17, wherein the first coding method is an end-to-end learned image coding method.

21. An apparatus according to claim 18, wherein the first set of algorithms of the second coding method reconstructs the another first decoded frame to be identical or substantially identical to the first decoded frame.

22. An apparatus according to claim 17, wherein the distortion is one or more of the following: a pixel-wise distortion; a feature-element-wise distortion; or a cross-entropy loss.

23. An apparatus according to claim 17, wherein the apparatus is further caused to: derive said one or more optimizing parameters by a rate-distortion optimization process.

24. An apparatus according to claim 17, wherein to signal said one or more optimizing parameters, the apparatus is further caused to:
encode said one or more optimizing parameters by the second coding method.

25. An apparatus according to claim 17, wherein the filter is an adaptive loop filter and to signal said one or more optimizing parameters, the apparatus is further caused to: include said one or more optimizing parameters into an adaptation parameter set defined by the second coding method.

26. An apparatus for decoding comprising: at least one processor; and at least one memory including computer program code; wherein the at least one memory and the computer program code are configured to, with the at least one processor, cause the apparatus at least to:
receive a first coded frame and a second coded frame;
receive one or more optimizing parameters;
decode the first coded frame into a first decoded frame using a first decoding method;
adjust a filter with the one or more optimizing parameters, where the one or more optimizing parameters reduce distortion of the first decoded frame to produce a first filtered frame;
filter the first decoded frame with the filter; and
decode the second coded frame into a second decoded frame by a second set of algorithms of a second decoding method and by using the first filtered frame directly or indirectly for prediction.

27. An apparatus according to claim 26, wherein the first decoding method is an end-to-end learned image decoding method.

28. A method for encoding, comprising:
receiving a video sequence comprising a first frame and a second frame;
encoding the first frame into a first coded frame using a first coding method;
reconstructing a first decoded frame corresponding to the first coded frame;
deriving one or more optimizing parameters to adjust a filter, wherein said one or more optimizing parameters reduce distortion of the first decoded frame to produce a first filtered frame;
filtering the first decoded frame with the filter;
encoding the second frame into a second coded frame by a second set of algorithms of a second coding method and by using the first filtered frame directly or indirectly for prediction; and
signaling said one or more optimizing parameters.

29. A method according to claim 28 further comprising:
encoding the first decoded frame by a first set of algorithms of the second coding method,
wherein the encoding further comprises:
reconstructing another first decoded frame, and
filtering the another first decoded frame with the filter using said one or more optimizing parameters into another first decoded and filtered frame, wherein the another first decoded and filtered frame is used directly for prediction of the second frame.

30. A method according to claim 28, wherein the deriving said one or more optimizing parameters comprises: deriving the distortion in relation to the first frame.

31. A method according to claim 28, wherein the first coding method is an end-to-end learned image coding method.

32. A method according to claim 29, wherein the first set of algorithms of the second coding method reconstructs the another first decoded frame to be identical or substantially identical to the first decoded frame.

33. A method according to claim 28, wherein the distortion is one or more of the following: pixel-wise distortion; feature-element-wise distortion; cross-entropy loss.

34. A method according to claim 28, wherein the deriving said one or more optimizing parameters comprises: a rate-distortion optimization process.

35. A method according to claim 28, wherein the signaling said one or more optimizing parameters comprises:
encoding said one or more optimizing parameters by the second coding method.

36. A method for decoding, comprising:
receiving a first coded frame and a second coded frame;
receiving one or more optimizing parameters;
decoding the first coded frame into a first decoded frame using a first decoding method;
adjusting a filter with said one or more optimizing parameters, wherein said one or more optimizing parameters reduce distortion of the first decoded frame to produce a first filtered frame;
filtering the first decoded frame with the filter; and
decoding the second coded frame into a second decoded frame by a second set of algorithms of a second decoding method and by using the first filtered frame directly or indirectly for prediction.
